(19) United States
(12) Patent Application Publication
(10) Pub. No.: US 2005/0015203 A1
(43) Pub. Date: Jan. 20, 2005

(54) Lane-changing support system

(75) Inventor: Hikaru Nishira, Kanagawa (JP)

Correspondence Address: FOLEY AND LARDNER;SUITE 500, 3000 K STREET NW, WASHINGTON, DC, 20007, US

(73) Assignee: NISSAN MOTOR CO., LTD.

(21) Appl. No.: 10/892,193

(22) Filed: Jul. 16, 2004

(30) Foreign Application Priority Data
Jul. 18, 2003 (JP) 2003-276666

(51) Int. Cl. G08G 1/16

(52) U.S. Cl. 701/301; 340/903; 340/436

(57) ABSTRACT

A lane-changing support system includes a processing unit sets an assumed traffic-merging end, predicts a driving behavior of each peripheral vehicle, and generates at least one host vehicle's manipulated-variable time series to be executed until the host vehicle reaches the assumed traffic-merging end. The processing unit determines whether the host vehicle's lane change is appropriately achievable when executing the manipulated-variable time series, and additionally determines which of gaps defined between the peripheral-vehicles traveling on a traffic lane of destination of lane-changing should be suited for an entry of the host vehicle in case of a decision result that the appropriate lane change is achievable by execution of the manipulated-variable time series. The processing unit transmits information regarding a correspondence between a current host vehicle's manipulated variable on the manipulated-variable time series and at least one lane-changing enabling gap to the driver.

### TECHNICAL FIELD

The present invention relates to a lane-changing support system or a traffic-merging support system mounted on an automotive vehicle, and specifically to the improvement of lane-changing support, traffic-merging support, and collision-avoidance support technologies.

### BACKGROUND ART

In recent years, there have been proposed and developed various lane-changing support, traffic merging support, and collision-avoidance support technologies. A lane-changing support system, capable of supporting a lane change by an ACC vehicle (an adaptive cruise control system equipped vehicle or a host vehicle), has been disclosed in Japanese Patent Provisional Publication No. 2000-20898 (hereinafter is referred to as “JP2000-20898”). Within an electronic control unit (ECU) incorporated in the lane-changing support system disclosed in JP2000-20898, a check is made, based on a relative distance and a relative velocity of the host vehicle relative to each of objects in the adjacent lane and in front of or in rear of the host vehicle leaving the current driving lane, whether a lane-changing operation is enabled or disabled. In the lane-changing enabling state, the ECU generates a lane-changing support signal or a traveling support signal based on the relative distance and the relative velocity, utilizing a preprogrammed vehicle's driving operation characteristic, so as to select a proper vehicle's driving operation model or a recommended vehicle's driving mode and to assist the driver's lane-changing action according to the selected driving operation model (the recommended vehicle's driving mode).

A traffic-merging support system (or a traffic-merging guide system), enabling the driver to grasp a proper traffic-merging timing and thus realizing a smooth traffic-merging operation, has been disclosed in Japanese Patent Provisional Publication No. 10-105884 (hereinafter is referred to as “JP10-105884”). The traffic-merging support system disclosed in JP10-105884 includes (i) a main lane vehicle information detector (a first measuring instrument) installed on a main lane in the vicinity of a traffic-merging area where the main lane merges into the adjacent traffic-merging lane, so as to detect information on a driving state of a main lane vehicle traveling on the main lane (e.g., information regarding the position, vehicle speed, and vehicle acceleration/deceleration of the main lane vehicle) and (ii) a traffic-merging lane vehicle information detector (a second measuring instrument) installed on the adjacent traffic-merging lane in the vicinity of the traffic-merging area to detect information on a driving state of a traffic-merging lane vehicle traveling on the adjacent traffic-merging lane (e.g., information regarding the position, vehicle speed, and vehicle acceleration/deceleration of the traffic-merging lane vehicle). The traffic-merging support system of JP10-105884 also includes (iii) an information transmitting device provided to transmit support information via a leakage coaxial cable, and comprised of a vehicle speed information transmitter, a traffic-merging timing information transmitter, and a relative position information transmitter, and (iv) vehicle-mounted display devices. The vehicle speed information transmitter transmits information about a main-lane vehicle speed guidance suitable for the main lane vehicle to a main-lane vehicle-mounted receiver in a manner so as to ensure a proper traffic-merging space, and simultaneously transmits information about a traffic-merging lane vehicle speed guidance suitable for the traffic-merging lane vehicle to a traffic-merging-lane vehicle-mounted receiver. The information on vehicle speed guidance for the main lane vehicle is indicated by the display mounted on the main-lane-vehicle instrument panel, whereas the information on vehicle speed guidance for the traffic-merging lane vehicle is indicated by the display mounted on the traffic-merging-lane-vehicle instrument panel. The traffic-merging timing information transmitter transmits information about a traffic-merging timing for the traffic-merging lane vehicle to the traffic-merging-lane vehicle-mounted receiver, so that the driver of the traffic-merging lane vehicle is informed of the proper traffic-merging timing via the display device, thus enabling the driver to grasp the proper traffic-merging timing. The relative position information transmitter transmits the position information of the main lane vehicle relative to the host vehicle when the host vehicle is the traffic-merging lane vehicle. Conversely when the host vehicle is the main lane vehicle, the relative position information transmitter transmits the position information of the traffic-merging lane vehicle relative to the host vehicle. The information indicated by the vehicle-mounted display devices of the main lane vehicle and the traffic-merging lane vehicle contributes to a more smooth traffic-merging operation.

A traffic-merging period collision-avoidance system (or a traveling object control system), capable of avoiding two vehicles from being brought into collision-contact with each other at the traffic-merging point, has been disclosed in Japanese Patent Provisional Publication No. 10-105895 (hereinafter is referred to as “JP10-105895”). The traffic-merging period collision-avoidance system disclosed in JP10 -105895 estimates a time of arrival of a traffic-merging lane vehicle to a traffic merging point and a time of arrival of a main lane vehicle to the same traffic merging point. When these estimated arrival times are substantially identical to each other, the system transmits information concerning vehicle control (concretely, a control command corresponding to required vehicle acceleration/deceleration) and/or collision warning information to at least one of the traffic-merging lane vehicle and the main lane vehicle, to avoid these vehicles from being brought into collision-contact with each other at the traffic-merging point.

### SUMMARY OF THE INVENTION

In the lane-changing support system disclosed in JP2000-20898, a decision for the enabling or disabling state of lane-changing is made by each lane-changing support control cycle. If the decision result represents the lane-changing disabling state, the host vehicle must be kept within the current host vehicle's driving lane until a transition from the lane-changing disabling state to the lane-changing enabling state occurs. However, in the actual traffic environment, a traffic situation that it is difficult or improper to keep the host vehicle within the current driving lane and thus a lane change by the host vehicle must be completed before the host vehicle reaches a predetermined point, for example, a traffic merging point, often takes place. Under such a traffic situation, the system disclosed in JP2000-20898 cannot give satisfactory lane-changing support information.

Accordingly, it is an object of the invention to provide a lane-changing support system, capable of generating and presenting satisfactory lane-changing support information needed to support a lane change by a host vehicle, even in a traffic situation that the host vehicle cannot be kept within the current driving lane owing to a traffic environment and thus a lane change by the host vehicle must be completed before the host vehicle reaches a predetermined point.

In order to accomplish the aforementioned and other objects of the present invention, a lane-changing support system comprises a host-vehicle driving-state detection section that detects a driving state of a host vehicle, a peripheral vehicle detection section that detects peripheral vehicles, a lane detection section that detects a lane marking around the host vehicle, a processing unit being configured to receive information from at least the host-vehicle driving-state detection section, the peripheral vehicle detection section, and the lane detection section, for generating support information on lane-changing support, the processing unit comprising an end-of-traffic-merging setting section that sets an assumed traffic-merging end serving as a temporary measure at which a lane change by the host vehicle has to be completed, a peripheral vehicle behavior prediction section that predicts a driving behavior of each of the peripheral vehicles, a host-vehicle manipulated variable setting section that generates at least one manipulated-variable time series of a host vehicle's manipulated variable to be executed during a time period from a time when a decision that there is a necessity of lane-changing has been made to a time when the host vehicle reaches the assumed traffic-merging end, a manipulated variable decision section connected to the peripheral vehicle behavior prediction section and the host-vehicle manipulated variable setting section for determining whether the lane change by the host vehicle is appropriately achievable when executing the manipulated-variable time series, generated by the host-vehicle manipulated variable setting section, and additionally determines which of gaps defined between the peripheral vehicles traveling on a traffic lane of destination of lane-changing should be suited for an entry of the host vehicle when the manipulated variable decision section determines that the appropriate lane change by the host vehicle is achievable by execution of the manipulated-variable time series, and a support information presentation section that transmits information regarding a correspondence between a current host vehicle's manipulated variable on the manipulated-variable time series determined by the manipulated variable decision section and at least one lane-changing enabling gap determined by the manipulated variable decision section, to the driver.

According to another aspect of the invention, a lane-changing support system comprises host-vehicle driving-state detection means for detecting a driving state of a host vehicle, peripheral vehicle detection means for detecting peripheral vehicles, lane detection means for detecting a lane marking around the host vehicle, a processing unit being configured to receive information from at least the host-vehicle driving-state detection means, the peripheral vehicle detection means, and the lane detection means, for generating support information on lane-changing support, the processing unit comprising end-of-traffic-merging setting means for setting an assumed traffic-merging end serving as a temporary measure at which a lane change by the host vehicle has to be completed, peripheral vehicle behavior prediction means for predicting a driving behavior of each of the peripheral vehicles, host-vehicle manipulated variable setting means for generating at least one manipulated-variable time series of a host vehicle's manipulated variable to be executed during a time period from a time when a decision that there is a necessity of lane-changing has been made to a time when the host vehicle reaches the assumed traffic-merging end, manipulated variable decision means connected to the peripheral vehicle behavior prediction means and the host-vehicle manipulated variable setting means for determining whether the lane change by the host vehicle is appropriately achievable when executing the manipulated-variable time series, generated by the host-vehicle manipulated variable setting means, and additionally determines which of gaps defined between the peripheral vehicles traveling on a traffic lane of destination of lane-changing should be suited for an entry of the host vehicle when the manipulated variable decision means determines that the appropriate lane change by the host vehicle is achievable by execution of the manipulated-variable time series, and support information presentation means for transmitting information regarding a correspondence between a current host vehicle's manipulated variable on the manipulated-variable time series determined by the manipulated variable decision means and at least one lane-changing enabling gap determined by the manipulated variable decision means, to the driver.

According to a still further aspect of the invention, a lane-changing support method comprises detecting a driving state of a host vehicle, detecting peripheral vehicles, detecting a lane marking around the host vehicle, generating support information on lane-changing support by processing information regarding the driving state of the host vehicle, the peripheral vehicles, and the lane marking around the host vehicle, the process for generating the support information comprising setting an assumed traffic-merging end serving as a temporary measure at which a lane change by the host vehicle has to be completed, predicting a driving behavior of each of the peripheral vehicles, generating at least one manipulated-variable time series of a host vehicle's manipulated variable to be executed during a time period from a time when a decision that there is a necessity of lane-changing has been made to a time when the host vehicle reaches the assumed traffic-merging end, based on the driving behavior of each of the peripheral vehicles and the manipulated-variable time series of the host vehicle's manipulated variable, determining whether the lane change by the host vehicle is appropriately achievable when executing the manipulated-variable time series, and additionally determining which of gaps defined between the peripheral vehicles traveling on a traffic lane of destination of lane-changing should be suited for an entry of the host vehicle in case of a decision result that the appropriate lane change by the host vehicle is achievable by execution of the manipulated-variable time series, and transmitting information regarding a correspondence between a current host vehicle's manipulated variable on the manipulated-variable time series determined and at least one lane-changing enabling gap determined, to the driver.

The other objects and features of this invention will become understood from the following description with reference to the accompanying drawings.

### BRIEF DESCRIPTION OF THE DRAWINGS

FIG. 1 is a layout drawing illustrating a first embodiment of a lane-changing support system.

FIG. 2 is a functional block diagram illustrating the lane-changing support system of the first embodiment shown in FIG. 1.

FIG. 3 is a top view of a highway in a first traffic situation in which the system of the first embodiment can be applied.

FIG. 4 is a characteristic map showing an example of time series data of a manipulated variable generated by a host-vehicle manipulated variable setting section under a condition that a distance-to-traffic-merging-end DTE is identical to a calculated host-vehicle travel distance s₀, that is, in case of DTE=s₀.

FIG. 5 is a characteristic map showing another example of time series data of a manipulated variable generated by a host-vehicle manipulated variable setting section in case of DTE>s₀.

FIG. 6 is a characteristic map showing another example of time series data of a manipulated variable generated by a host-vehicle manipulated variable setting section in case of DTE<s₀.

FIG. 7 is an explanatory view showing the relationship between an end-of-traffic-merging arrival time and a traffic-merging enabling gap in the system of the first embodiment.

FIG. 8 is an explanatory view showing the correspondence (mapping) between an initial value of the manipulated-variable time series and the traffic-merging enabling gap in the system of the first embodiment.

FIG. 9 is an explanatory view showing arithmetic and logic processing executed by a support information presentation section of the system of the first embodiment.

FIG. 10 is an explanatory view showing a method to present support information by means of the support information presentation section of the system of the first embodiment.

FIG. 11 is a flow chart showing a lane-changing support routine executed by the system of the first embodiment.

FIG. 12 is a layout drawing illustrating a second embodiment of a lane-changing support system.

FIG. 13 is a top view of a highway in a second traffic situation in which the system of the second embodiment can be applied.

FIG. 14 is an explanatory view showing arithmetic and logic processing executed by the support information presentation section of the system of the second embodiment.

FIG. 15 is a schematic diagram showing a display information selector switch of the system of the second embodiment.

FIG. 16 is an explanatory view showing the relationship between a selected dial-switch position by the display information selector switch and displayed support information.

FIG. 17 is a layout drawing illustrating a third embodiment of a lane-changing support system.

FIG. 18 is a top view of a highway in a third situation in which the system of the third embodiment can be applied.

FIGS. 19A-19C are explanatory views of accelerator-pedal reaction adjustment achieved by the system of the third embodiment.

FIG. 20 is a layout drawing illustrating a fourth embodiment of a lane-changing support system.

FIG. 21 is a top view of a highway in a fourth traffic situation in which the system of the fourth embodiment can be applied.

FIG. 22 is an explanatory view showing a method to present the support information by means of the support information presentation section of the system of the fourth embodiment.

FIG. 23 is a flow chart showing a lane-changing support routine executed by the system of the fourth embodiment.

### DESCRIPTION OF THE PREFERRED EMBODIMENTS

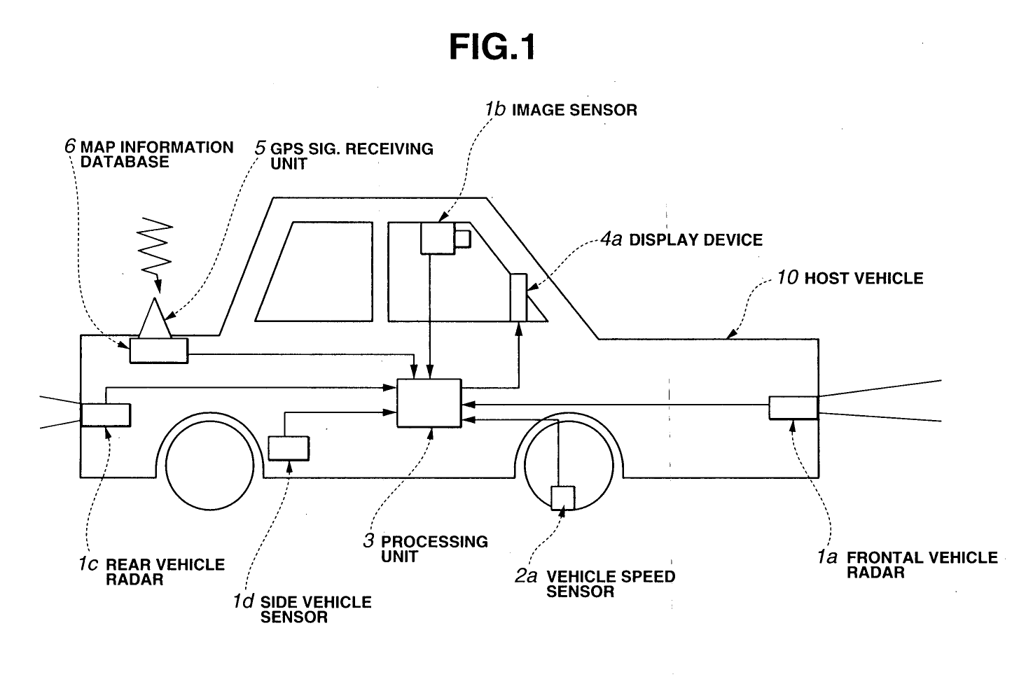

Referring now to the drawings, particularly to FIGS. 1-11, there is shown the automotive lane-changing support system (or the automotive traffic-merging support system) of the first embodiment. FIG. 1 shows the schematic layout of components constructing the lane-changing support system of the first embodiment. In FIG. 1, a frontal vehicle radar sensor 1a is installed on the front face of a host vehicle 10, for detecting or measuring positions of a plurality of peripheral vehicles in front of host vehicle 10. An image sensor 1b, such as a stereo-camera using a charge-coupled device (CCD) image sensor, is also installed on the front face of host vehicle 10, such as a roof panel, for detecting a lane marker or lane marking, such as a white line on the road. Image sensor 1b also serves to fully complement the information measured or detected by frontal vehicle radar sensor 1a. On the other hand, a rear vehicle radar sensor 1c is installed on the back-face of host vehicle 10, for detecting or measuring positions of a plurality of vehicles in rear of host vehicle 10. A pair of side vehicle sensors 1d, 1d are mounted on both sides of host vehicle 10, for detecting or measuring positions of a plurality of peripheral vehicles, positioned on the sides of host vehicle 10 and located within a dead zone outside of the field of view of each of front and rear vehicle radar sensors 1a and 1c. A scanning laser radar sensor is often used as the side vehicle sensor 1d. In lieu thereof, an ultrasonic-wave sensor or an image sensor may be used as side vehicle sensor 1d. Also provided is a vehicle speed sensor 2a, which is comprised of a magnetic rotary encoder mounted at a road wheel. Vehicle speed sensor 2a generates a vehicle-speed indicative pulse signal (or a wheel-speed indicative pulse signal), which is based on an induced electromotive force corresponding to the rotational frequency of the rotary-encoder attached to the associated road wheel. The sensor signal generated vehicle speed sensor 2a is used to calculate a measured vehicle speed value of host vehicle 10. An electronic arithmetic and logic processing unit (simply, a processing unit) 3 is incorporated in the lane-changing support system of the embodiment, for carrying various support programs (described later) stored in memories. Processing unit 3 of the lane-changing support system of the embodiment generally comprises a microcomputer and its peripheral components. Processing unit 3 includes an input/output interface (I/O), memories (RAM, ROM), and a microprocessor or a central processing unit (CPU). The input/output interface (I/O) of processing unit 3 receives input information from various engine/vehicle switches and sensors, namely frontal vehicle radar sensor 1a, image sensor 1b, rear vehicle radar sensor 1c, side vehicle sensors 1d, 1d, and vehicle speed sensor 2a. Within processing unit 3 of the lane-changing support system, the central processing unit (CPU) allows the access by the I/O interface of input informational data signals from the previously-discussed engine/vehicle switches and sensors 1a, 1b, 1c, 1d, 1d, and 2a. The CPU of processing unit 3 is responsible for carrying the lane-changing support program stored in memories and is capable of performing necessary arithmetic and logic operations containing a lane-changing support and/or traffic-merging support processing. Computational results (arithmetic calculation results), that is, calculated output signals are relayed through the output interface circuitry of processing unit 3 to output stages, namely a display device 4a (incorporated in the system of the first, second, third, and fourth embodiments), and a reaction motor 20 (incorporated in the system of the third embodiment).

Display device 4a also comprises an information-indication display, for example a liquid crystal display, a microcomputer and its peripheral components. The microcomputer and the peripheral electronic parts of display device 4a are used for image-processing and drawing or plotting image data to be indicated by the liquid crystal display. Concretely, the microcomputer and the peripheral electronic parts of display device 4a serve for image-processing an image data signal generated from the output interface of processing unit 3 in accordance with an image-processing and drawing program stored in the memory, in a manner such that effective support information (or helpful guidance) is given to the driver by visually indicating the image on the display. Additionally, the microcomputer and the peripheral components of display device 4a also serve to inform the driver about the support information by audibly reproducing predetermined or preprogrammed audible data based on the support information selected. That is, the system enables presentation of the visual and audible support information to the driver.

A global positioning system (GPS) signal receiving unit 5 receives a signal from a global positioning system (another infrastructure), such that GPS signal receiving unit 5 anywhere on earth is informed of a current three-dimensional position of host vehicle 10. The current traveling road of host vehicle 10 is identified by collating the current host vehicle's position calculated by GPS signal receiving unit 5 with information on the road networks stored in a map information database 6.

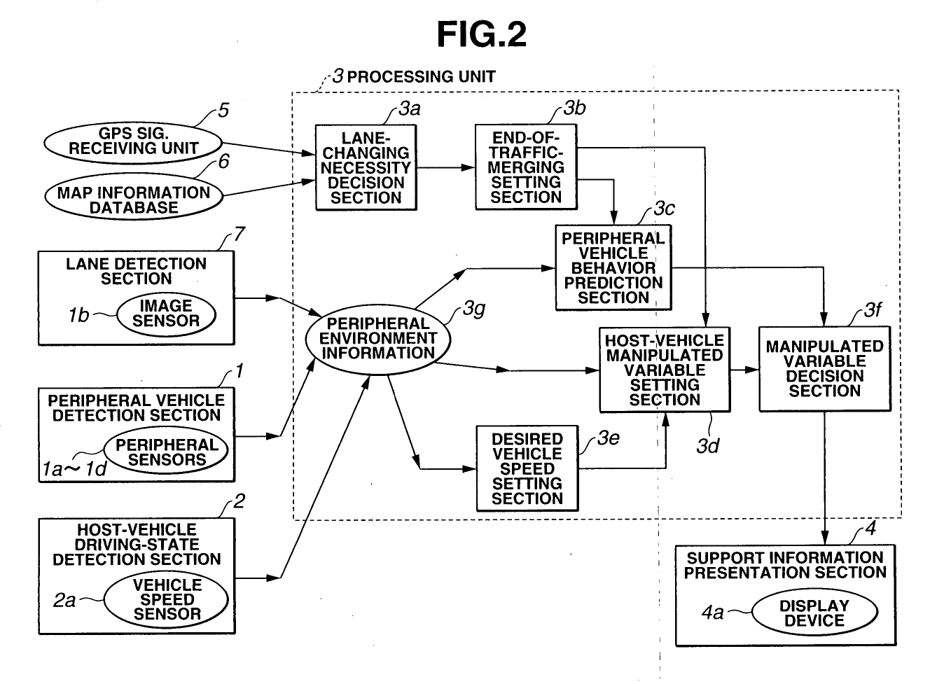

Referring now to FIG. 2, there is shown the functional block diagram of the lane-changing support system of the first embodiment. As shown in FIG. 2, in accordance with a predetermined software configuration, processing unit 3 is comprised of a plurality of blocks, namely, a lane-changing necessity decision section (lane-changing necessity decision means) 3a, an end-of-traffic-merging setting section (end-of-traffic-merging setting means) 3b, a peripheral vehicle behavior prediction section (peripheral vehicle behavior prediction means) 3c, a host-vehicle manipulated variable setting section (host-vehicle manipulated variable setting means) 3d, a desired vehicle speed setting section (desired vehicle speed setting means) 3e, and a manipulated variable decision section (manipulated variable decision means) 3f. As can be seen from the functional block diagram of FIG. 2, a host-vehicle driving-state detection section (host-vehicle driving-state detection means) 2 is comprised of vehicle sensor 2a. A peripheral vehicle detection section (peripheral vehicle detection means) 1 is comprised of peripheral sensors, containing frontal vehicle radar sensor 1a, image sensor 1b, rear vehicle radar sensor 1c, and side vehicle sensor pair (1d, 1d). A lane detection section (lane detection means) 7 is comprised of image sensor 1b capable of detecting a lane marker or lane marking, such as a white line on roads. A support information presentation section (support information presentation means) 4 is comprised of display device 4a. In FIG. 2, reference sign 3g denotes peripheral environment information temporarily stored in the memory of processing unit 3.

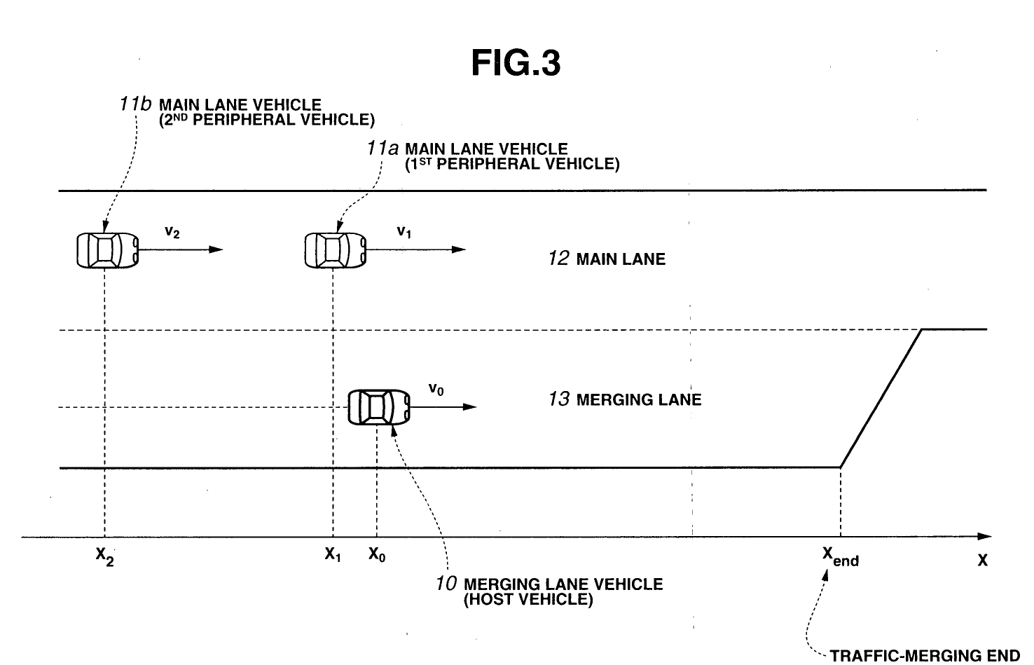

Support information processing executed by the system of the first embodiment is hereunder described in reference to the first traffic situation shown in FIG. 3. In FIG. 3, a lane 13, which gradually vanishes into nothing, is hereinafter referred to as “traffic-merging lane”. A lane 12, which is closely juxtaposed to the traffic-merging lane and extends continually, is hereinafter referred to as “main lane”. A vehicle 10, which travels on the traffic-merging lane, is hereinafter referred to as “traffic-merging lane vehicle”, whereas a vehicle (11a, 11b), which travels on the main lane, is hereinafter referred to as “main lane vehicle”. More concretely, FIG. 3 shows the first traffic situation in which host vehicle 10 travels on traffic-merging lane 13, and other vehicles, namely a first peripheral vehicle 11a and a second peripheral vehicle 11b, both travel on main lane 12, in a certain highway section that traffic-merging lane 13 is connected to main lane 12 consisting of a single lane.

As shown in FIG. 3, an x-axis is taken in the traveling direction of the highway where the origin of coordinates can be taken in an arbitrary point on earth. X-coordinates of host vehicle 10 (the traffic-merging lane vehicle), and first and second peripheral vehicles 11a and 11b (the main lane vehicles) are respectively denoted as x₀, x₁, and x₂. Vehicle velocities (vehicle speeds) of the three vehicles 10, 11a and 11b in their traveling directions are respectively denoted as v₀, v₁, and v₂. Traffic-merging lane 13 completely vanishes into nothing at its downstream end, so that traffic-merging lane 13 and main lane 12 are merged into a single lane. Thus, the traffic merging operation of traffic-merging lane vehicle 13 (host vehicle 10) must be completed or terminated, until traffic-merging lane 13 completely vanishes into nothing. Generally, there is a less possibility of lane-changing of each of first and second peripheral vehicles 11a and 11b (both traveling on main lane 12) from main lane 12 to traffic-merging lane 13. Thus, suppose that each of the other vehicles 11a and 11b continues to travel on main lane 12.

Assuming that the origin of coordinates has been arbitrarily taken and thus the x-coordinate x₀ of host vehicle 10 has been determined, it is possible to determine the x-coordinates x₁ and x₂ of first and second peripheral vehicles 11a and 1b, on the basis of the relationship of relative position (relative distance) of host vehicle 10 relative to each of first and second peripheral vehicles 11a and 11b. These relative-position relationships are determined based on input information from peripheral sensors 1a, 1b, 1c, 1d, and 1d, all constructing peripheral vehicle detection section (peripheral vehicle detection means) 1. Additionally, a vehicle speed v₀ of host vehicle 10 can be determined based on input information from vehicle speed sensor 2a constructing host-vehicle driving-state detection section (host-vehicle driving-state detection means) 2. A relative speed of first peripheral vehicle 11a to host vehicle 10 and a relative speed of second peripheral vehicle 11b to host vehicle 10 can be determined based on input information from peripheral sensors 1a-1d by way of differentiation for each of the relative distances. A vehicle speed v₁ of first peripheral vehicle 11a can be arithmetically calculated by adding the host vehicle's speed v₀ to a relative velocity of first peripheral vehicle 11a to host vehicle 10. In a similar manner, a vehicle speed v₂ of second peripheral vehicle 11b can be arithmetically calculated by adding the host vehicle's speed v₀ to a relative velocity of second peripheral vehicle 11b to host vehicle speed 10. The fact that first and second peripheral vehicles 11a and 11b are traveling on main lane 12 can be recognized by utilizing lane marker information (or white line information) from image sensor. 1b constructing lane detection section (lane detection means) 7. As can be seen from the functional block diagram of FIG. 2, sensor signals from peripheral sensors 1a-1d and vehicle speed sensor 2a are all transmitted into processing unit 3. According to the previously-discussed processing, the values x₀, x₁, x₂, v₀, v₁, and V₃ are determined based on input information from sensors 1a-1d and 2a. Input information data from these sensors are collected, well arranged, and stored in the memory as peripheral environment information 3g (see FIG. 2).

The current three-dimensional position and the current driving lane of host vehicle 10 are both specified or identified by means of GPS signal receiving unit 5 and map information database 6. Thus, it is possible to detect or recognize a state that a traffic-merging point exists in front of host vehicle 10 and the current host vehicle's driving lane (the traffic-merging lane) merges into main lane 12 and gradually vanishes into nothing. Lane-changing necessity decision section 3a determines that there is a necessity of a lane change by host vehicle 10, when detecting such a state that the traffic-merging point exists in front of host vehicle 10 and the current host vehicle's driving lane merges into main lane 12 and gradually vanishes into nothing. In this case, the process of end-of-traffic-merging setting section (end-of-traffic-merging setting means) 3b is carried and executed, such that an assumed traffic-merging end or a hypothetical traffic-merging end (simply, a traffic-merging end) x_{end} is generated and determined or set as an arbitrary position before the traffic-merging point (more precisely, a lane-termination point that the traffic-merging lane physically completely vanishes into nothing). As a matter of course, there is no necessary for traffic-merging end x_{end} to be always identical to a lane-narrowing point that the traffic-merging lane physically begins to narrow. Traffic-merging end x_{end} can be arbitrarily set or determined or estimated by end-of-traffic-merging setting section 3b, such that a proper traffic-merging operation (a proper lane-changing operation) can be achieved or realized. For the purpose of simplification of the disclosure, in the top view of FIG. 3, traffic-merging end x_{end} is set or determined as the lane-narrowing point at which the traffic-merging lane physically begins to narrow.

Suppose that the traffic-merging operation of host vehicle 10 is achieved in the first traffic situation shown in FIG. 3. Generally, there are the following three ways to achieve the host vehicle's traffic-merging operation.

(1) One way to achieve the traffic-merging operation is the host vehicle's entry into the front space of first peripheral vehicle 11a.

(2) Another way to achieve the traffic-merging operation is the host vehicle's entry into the intermediate space defined between first and second peripheral vehicles 11a and 11b.

(3) Another way to achieve traffic-merging operation is the host vehicle's entry into the rear space of second peripheral vehicle 11b.

As a measure necessary to determine which of the aforementioned three ways is more appropriate, the system of the first embodiment uses end-of-traffic-merging arrival times corresponding to estimated values of arrival times that respective vehicles 10, 11a, and 11b reach traffic-merging end x_{end}. Assuming that the end-of-traffic-merging arrival time of the traffic-merging lane vehicle (host vehicle 10) traveling on traffic-merging lane 13 is substantially identical to that of at least one of the main lane vehicles (first and second peripheral vehicles 11a and 11b) traveling on main lane 12, there is an increased tendency for the traffic-merging lane vehicle and the main lane vehicle to travel in parallel with each other in the vicinity of traffic-merging end x_{end}. In such a case, the difficulty of providing a proper traffic-merging operation is predictable. Therefore, it is necessary to plan or program a proper traffic-merging operation so that there is a proper time difference between the end-of-traffic-merging arrival time of the traffic-merging lane vehicle (host vehicle 10) and the end-of-traffic-merging arrival time of each main lane vehicle. For the purpose of simplicity of the disclosure, in the top view of FIG. 3, the previously-discussed traffic-merging end x_{end} is indicated as the lane-narrowing point where the traffic-merging lane begins to narrow. As can be appreciated from the planar structure of the highway shown in FIG. 3, during the host vehicle's traffic-merging operation, host vehicle 10 does not always enter the main lane at only the previously-discussed traffic-merging end x_{end}. If there is a chance of host vehicle's lane-changing from traffic-merging lane 13 to main lane 12, host vehicle 10 can enter traffic-merging lane 13 before host vehicle 10 reaches traffic-merging end x_{end}. For the purpose of simplification of the disclosure, in the system of the shown embodiment, a logic of lane-changing support (traffic-merging support) is designed or programmed in a manner so as to utilize a decision result (evaluation) determined based on traffic-merging end x_{end}, which serves as an evaluation criterion for a possibility of optimal traffic-merging operation or a criterion for an enabling or disabling state of a lane change by host vehicle 10. In other words, traffic-merging end x_{end} is used as a temporary measure or a target point at which a lane change by host vehicle 10 has to be completed. In determining a possibility of traffic-merging operation of host vehicle 10, suppose that a preset margin for determination is provided. As a matter of course, such a preset margin for determination allows the host vehicle's entry into main lane 12 at a certain point before traffic-merging end x_{end}. In such a situation that there is a chance of host vehicle's lane-changing from traffic-merging lane 13 to main lane 12 before traffic-merging end x_{end}, the host vehicle's traffic-merging operation can be performed on the driver's judgment. Therefore, in constructing or designing the operation support system enabling lane-changing support and traffic-merging support, simplification (the use of traffic-merging end x_{end} rather than using a combination of traffic-merging end x_{end} and the margin as a criterion for evaluation) is a small matter.

On the assumption that both of first and second peripheral vehicles (main lane vehicles) 11a and 11b are running at the same constant speed, that is, v₁=v₂, the end-of-traffic-merging arrival time of the first main lane vehicle (first peripheral vehicle 11a) and the end-of-traffic-merging arrival time of the second main lane vehicle (second peripheral vehicle 11b) are arithmetically calculated from the following expression (1).
TTE₁=(x_{end}−x₁)/v₁ TTE₂=(x_{end}−x₂)/v₂ (1)
where TTE₁ denotes the end-of-traffic-merging arrival time of the first main lane vehicle (first peripheral vehicle 11a), and TTE₂ denotes the end-of-traffic-merging arrival time of the second main lane vehicle (second peripheral vehicle 11b), x₁ and x₂ denote the respective x-coordinates of first and second peripheral vehicles 11a and 11b, and x_{end} denotes the assumed traffic-merging end.

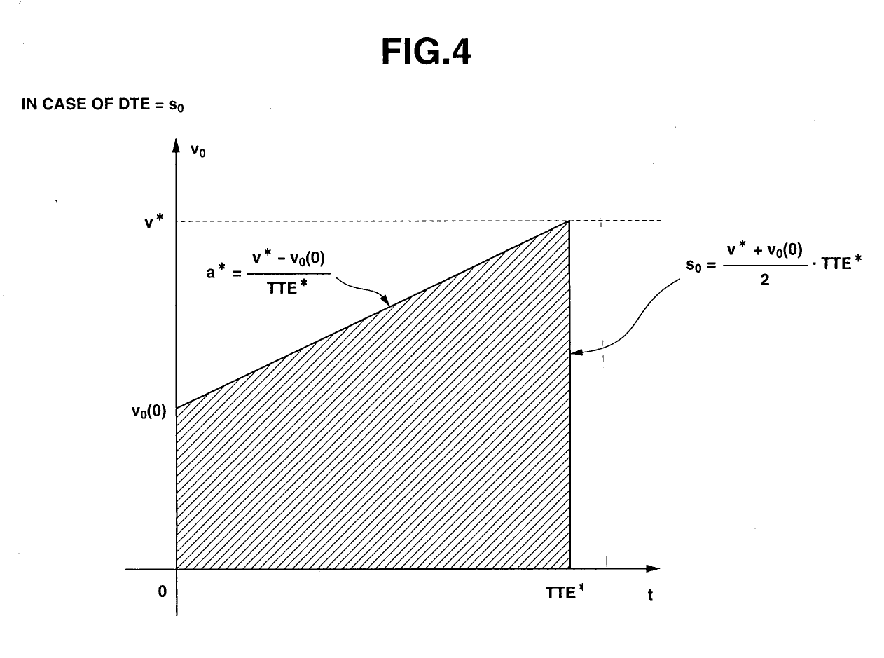

If each of the main lane vehicles (first and second peripheral vehicles 11a and 11b) is accelerating or decelerating, and thus the aforementioned assumption (the same constant-speed driving of main lane vehicles 11a and 11b) is unsatisfied, the system can properly compensate for the previously-noted expression (1), taking into account the accelerating rate or decelerating rate of each main lane vehicle. As discussed above, the arithmetic processing needed to calculate end-of-traffic-merging arrival times TTE₁ and TTE₂ of the main lane vehicles (first and second peripheral vehicles 11a and 11b) is executed within peripheral vehicle behavior prediction section (peripheral vehicle behavior prediction means) 3c. On the other hand, host-vehicle manipulated variable setting section (host-vehicle manipulated variable setting means) 3d generates time series data (a preprogrammed TTE*−v*−a* characteristic) of a host vehicle's manipulated variable (i.e., the host vehicle's acceleration/deceleration) to be determined until host vehicle 10 reaches traffic-merging end x_{end}. The time series data of the host vehicle's manipulated variable will be hereinafter referred to as “manipulated-variable time series data”. There are several ways to determine and generate the host vehicle's manipulated variable. In the system of the shown embodiment, a desired host vehicle speed (simply, a desired vehicle speed) v* and a desired end-of-traffic-merging arrival time TTE* at traffic-merging end x_{end} are both used or given as essential conditions. Concrete techniques to determine and generate the host vehicle's manipulated variable that satisfies the essential conditions are hereinafter described in detail in reference to FIGS. 4-8.

FIG. 4 shows one example of the host vehicle's manipulated-variable time series data generated by host-vehicle manipulated variable setting section 3d under a predetermined condition (DTE=s₀) where a distance-to-traffic-merging-end DTE from the host vehicle's x coordinate x₀ to the estimated traffic-merging end x_{end} is identical to a calculated travel distance s₀ (={(v*+v₀(0))/2}TTE*) of host vehicle 10 from the host vehicle's x-coordinate x₀ (a reference position), calculated based on desired vehicle speed v* and desired end-of-traffic-merging arrival time TTE*.

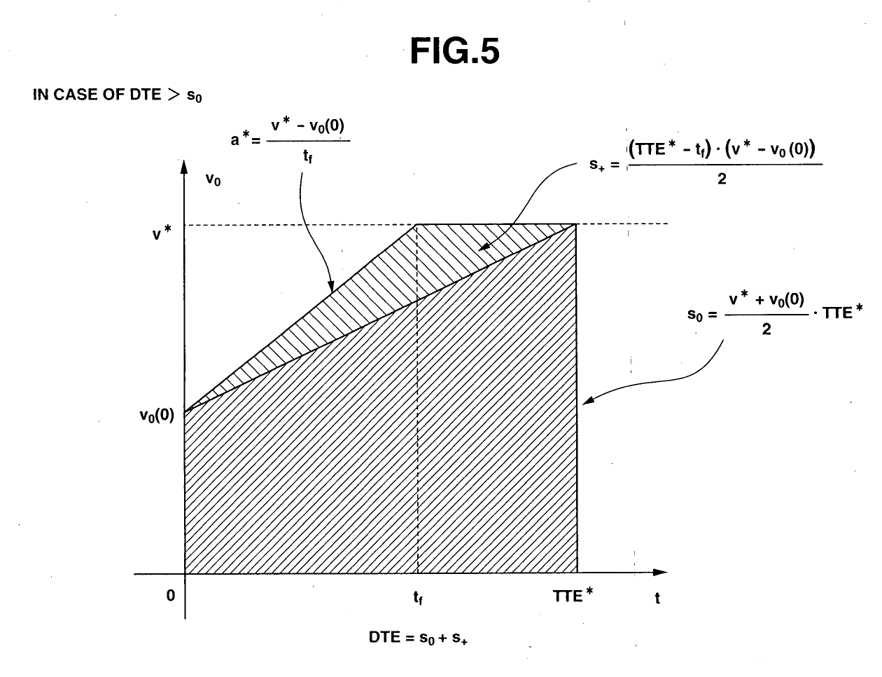

FIG. 5 shows another example of the host vehicle's manipulated-variable time series data generated by host-vehicle manipulated variable setting section 3d under a predetermined condition (DTE>s₀) where distance-to-traffic-merging-end DTE is greater than the calculated travel distance s₀ (=(v*+v₀(0))/2)

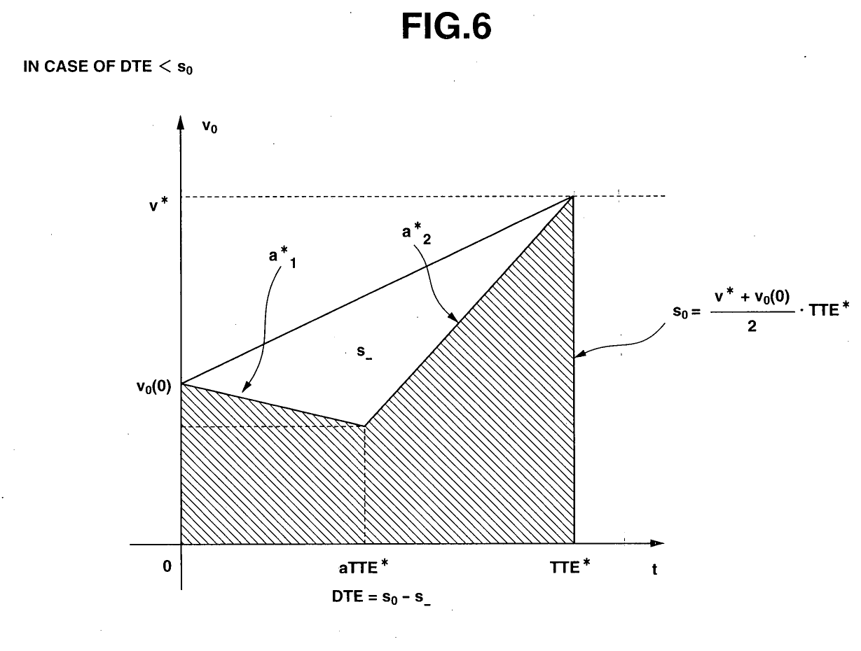

FIG. 6 shows another example of the host vehicle's manipulated-variable time series data generated by host-vehicle manipulated variable setting section 3d under a predetermined condition (DTE<s₀) where distance-to-traffic-merging-end DTE is less than the calculated distance s₀ (=(v*+v₀(0))/2).

In FIG. 4 showing the host vehicle's manipulated-variable time series data generated by host-vehicle manipulated variable setting section 3d under the predetermined condition (DTE=s₀), a* denotes a desired host vehicle acceleration, which is represented by the expression a*=(v*−v₀(0))/TTE*. Calculated travel distance s₀ based on desired vehicle speed v* and desired end-of-traffic-merging arrival time TTE* is calculated as the product of (i) a simple average (v*+v₀(0))/2 of desired vehicle speed v* and a host vehicle's speed v₀(0) calculated at the x-coordinate x₀(0) at the current control cycle, and (ii) desired end-of-traffic-merging arrival time TTE*, and thus represented by the expression s₀={(v*+v₀(0))/2}×TTE*.

In FIG. 5 showing the host vehicle's manipulated-variable time series data generated by host-vehicle manipulated variable setting section 3d under the predetermined condition (DTE>s₀), distance-to-traffic-merging-end DTE is represented by the expression DTE=s₀+s+. Desired acceleration a* is represented by the expression a*=(v*−v₀(0))/t_{f}, where t_{f} denotes an accelerating-mode termination time where the accelerating mode of host vehicle 10 is finished and thus the host vehicle's speed reaches desired vehicle speed v*. In this case, the distance difference s₊ is represented by the expression s₊=[(TTE*−t_{f})×(v*−v₀(0))}/2.

In FIG. 6 showing the host vehicle's manipulated-variable time series data generated by host-vehicle manipulated variable setting section 3d under the predetermined condition (DTE<s₀), distance-to-traffic-merging-end DTE is represented by the expression DTE=s₀−s₋.

As hereunder described in detail, the system of the first embodiment has to compute or determine such a host vehicle's manipulated-variable time series data that host vehicle 10 is timed to reach or arrive at traffic-merging end x_{end} at the desired end-of-traffic-merging arrival time TTE* (or after the desired elapsed time, which is measured or counted from a point at which host vehicle passes through the x-coordinate x₀), and additionally the host vehicle speed becomes desired vehicle speed v* at traffic-merging end x_{end}. As a host vehicle's acceleration range generally used during traffic-merging operation, upper and lower limits aₘₐₓ and aₘᵢₙ of a traffic-merging period host-vehicle acceleration or a lane-changing period host-vehicle acceleration are preset. That is to say, during traffic-merging operation or during lane-changing operation, the maximum allowable host vehicle's acceleration range is defined by the inequality aₘᵢₙ≦a≦aₘₐₓ. Therefore, the system of the shown embodiment determines and generates a traffic-merging pattern within the predetermined acceleration range aₘᵢₙ≦a≦aₘₐₓ. In transient host vehicle's driving behavior analyses, the vehicle's acceleration pattern (the waveform of host vehicle acceleration) is determined depending on the types or shapes of engines mounted on vehicles or power-train characteristics. For the sake of simplicity, the host vehicle's acceleration pattern is approximately assumed and defined as a uniformly accelerated motion (see the time rate of change in the host vehicle's speed v₀, gradually increasing in a linear fashion in FIG. 4).

As shown in FIG. 4, there is a situation where host vehicle 10 is accelerated from the initial vehicle speed v₀ to desired vehicle speed v*, and thereafter the host vehicle arrives traffic-merging end x_{end} just when the host vehicle's speed reaches desired vehicle speed v*, and at the same time the accelerating mode terminates. Such a situation occurs when the following equation (2) is satisfied. In more detail, this situation occurs under the condition where the previously-noted distance-to-traffic-merging-end DTE (=x_{end}−x₀(0)) from host vehicle's x coordinate x₀ to the estimated traffic-merging end x_{end} is identical to the calculated travel distance s₀. That is, distance-to-traffic-merging-end DTE is represented by the following equation (2).
S₀={(v₀(0)+v*)/2}TTE*=DTE (2)
In this case, desired acceleration a*(t) of host vehicle 10 is represented by the following expression (3), on the assumption that a desired acceleration value a₀*, calculated at x-coordinate x₀(0) at the current control cycle, is equal to a value {(v*−v₀(0))/TTE*}, that is, a₀*={(v*−v₀(0))/TTE*}.
a*(t)=a₀*={(v*−v₀(0))/TTE*} (for 0≦t≦TTE*) (3)
In the event that the condition defined by a*(t)=a₀*>aₘₐₓ is satisfied under the condition of DTE=s₀, the system of the shown embodiment determines that it is impossible to accomplish or achieve the desired value computed (or the manipulated variable computed).

FIG. 5 shows another situation where the following inequality (4) is satisfied.
[{v₀(0)+v*}/2]TTE*<DTE (4)
In this case, assuming that host vehicle 10 is operated at desired acceleration a*(t) (=a₀*) set by the expression (3), the host vehicle cannot arrive traffic-merging end x_{end} by the previously-noted desired end-of-traffic-merging arrival time TTE*. Thus, the vehicle acceleration must be set to an acceleration value higher than desired acceleration a₀*. As can be seen from the upper polygonal line in FIG. 5, on the assumption that the accelerating mode terminates as soon as the host vehicle speed reaches desired vehicle speed v* at the time t_{f}, which is defined between the time point (the origin O shown in FIG. 5) corresponding to host vehicle's x-coordinate x₀ and the desired end-of-traffic-merging arrival time TTE*, and thereafter the host vehicle speed remains constant, desired vehicle acceleration a*(t) varies depending on before or after the time point t_{f} of accelerating-mode termination, as follows.
a*(t)=(v*−v₀(0))/t_{f} (for 0≦t≦t_{f})
a*(t)=0 (for t_{f}≦t≦TTE*) (5)
As explained previously, under the condition defined by DTE>s₀, the pattern of desired vehicle acceleration a*(t) is set or determined by the above-mentioned expression (5). The acceleration-mode termination time t_{f} is given by the following expression (6).
[{v*+v₀(0)}/2)TTE*+{(TTE*−t_{f}) (v*−v₀(0))}/2=DTE
t_{f}=TTE*−{2·DTE−v*−v₀(0)}/{v*−v₀(0)} (6)
In the event that the condition defined by a*(t)=a₀*>aₘₐₓ is satisfied under the condition of DTE>s₀, the system of the shown embodiment determines that it is impossible to accomplish the desired value computed (or the manipulated variable computed).

FIG. 6 shows another situation where the following inequality (7) is satisfied.
[{v₀(0)+v*}/2]TTE*>DTE (7)
In this case, assuming that host vehicle 10 is operated at desired vehicle acceleration a*(t) (=a₀*) set by the expression (3), the host vehicle arrives traffic-merging end x_{end} before the host vehicle speed is accelerated up to desired vehicle speed v*. Thus, during the former half (early stages) of the host vehicle's traffic-merging operation, it is necessary to moderately accelerate host vehicle 10 at an acceleration rate lower than desired acceleration value a₀* or to moderately decelerate host vehicle 10 at a small deceleration rate. In order for the host vehicle speed to become identical to desired vehicle speed v* at the desired end-of-traffic-merging arrival time TTE*, during the latter half of the host vehicle's traffic-merging operation it is necessary to quickly accelerate host vehicle 10 at an acceleration rate higher than desired acceleration a(t)*=(v*−v₀(0))/t_{f} set by the expression (5). For the reasons discussed above, in case of DTE<s₀, the vehicle's acceleration pattern is calculated and determined by the following expression (8)
a*(t)=a₁* (for 0≦t≦α·TTE*)
a*(t)=a₂* (for α·TTE*≦t≦TTE*) (8)
where the values α, a₁*, and a₂* are constant values respectively defined by the following inequalities (9), (10), and (11).
0≦α≦1 (9)
aₘᵢₙ≦a₁*<a₀* (10)
a₀*<a₂*≦aₘₐₓ (11)
The conditions that satisfy the relationship between desired end-of-traffic-merging arrival time TTE* and desired vehicle speed v*, obtained when the acceleration pattern defined by the expression (8) is specified or selected, are represented by the following expressions (12) and (13).
v₀+a₁*·α·TTE*+a₂*·(1−α)·TTE*=v* (12)
{(v₀+v₀+a₁*·α·TTE*)/2}·α·TTE*+{(v₀+a₁*·α·TTE*+v*)/2}·(TTE*−αTTE*)={(v₀+v₀+a₁*·α·TTE*)/2}·α·TTE*+{(v₀+a₁*·α·TTE*+v*)/2}·(1−α)·TTE*=DTE (13)
From the above expressions (12) and (13), the constant values a₁* and a₂* are respectively given by the following expressions (14) and (15).
a₁*=(2·DTE)/{α(TTE*)²}−{(1+α)v₀+(1−α)v*}/αTTE* (14)
a₂*=−(2·DTE)/{(1−α)(TTE*)²}+{αv₀+(2−α)v*}/(1−α)TTE* (15)
It is possible to determine the concrete values of constants a₁* and a₂* by setting the constant value a in a manner such that the constant values a₁* and a₂* given by the expressions (14) and (15) satisfy the conditions defined by the inequalities (9), (10), and (11). There are several methods to set the constant value α. One method to set the constant value a is to satisfy a new condition that the difference |a₁*−a₂*| between two constants a₁* and a₂* has to be minimized. By adding the new condition, that is, the minimized difference |a₁*−a₂*|, it is possible to univocally determine the constant value α. In the event that such a constant value a that satisfies the conditions defined by the inequalities (9), (10), and (11) does not exist, the system of the shown embodiment determines that it is impossible to accomplish the desired value computed (or the manipulated variable computed).

The previously-discussed process is repeatedly executed with respect to the desired value pair, namely desired vehicle speed v* and desired end-of-traffic-merging arrival time TTE*, so as to generate the host vehicle's manipulated-variable time series data. Such processes repeatedly executed correspond to arithmetic processing of host-vehicle manipulated variable setting section 3d. Desired vehicle speed v* of host vehicle 10 is set or determined within desired vehicle speed setting section (desired vehicle speed setting means) 3e. The setting process for desired vehicle speed v* is hereunder described in detail.

During the traffic-merging operation in which host vehicle 10 (the traffic-merging lane vehicle) enters main lane 12, the relative distance from host vehicle 10 to each of peripheral vehicles 11a and 11b traveling on main lane 12 at the actual traffic-merging time point, and the vehicle speed of host vehicle 10 traveling on traffic-merging lane 13 at the actual traffic-merging time point, are both taken into account. In particular, during traffic-merging operation through a ramp way of the highway, the vehicle speed difference between the main lane vehicle speed and the traffic-merging lane vehicle speed is often great. In such a case (owing to a comparatively, excessively higher main-lane vehicle speed), it is necessary to determine whether appropriate traffic-merging operation (or appropriate lane-changing operation) is enabled or disabled, while taking an accelerating/decelerating operation of the traffic-merging vehicle (host vehicle 10) into consideration. For the reasons discussed above, desired vehicle speed setting section (desired vehicle speed setting means) 3e sets or determines the host vehicle's traffic-merging speed (desired vehicle speed v* of host vehicle 10 during traffic-merging operation) based on the main-lane vehicle speed, serving as a reference. For instance, an average value {(v₁+v₂)/2} of the main-lane vehicle speeds (i.e., first and second peripheral vehicle's speeds v₁ and v₂) may be simply used as the reference speed. In more detail, in the first traffic situation shown in FIG. 3, desired vehicle speed v* of host vehicle 10 is determined based on the simple mean of first and second peripheral vehicle's speeds v₁ and v₂ and thus represented by the following expression (16).
v*=(v₁+v₂)/2 (16)
In lieu thereof, desired vehicle speed v* of host vehicle 10 may be determined as a lower one of the main-lane vehicle speeds (i.e., first and second peripheral vehicle's speeds v₁ and v₂) from the following expression (17) by way of a so-called select-LOW process.
v*=min(v₁, v₂) (17)

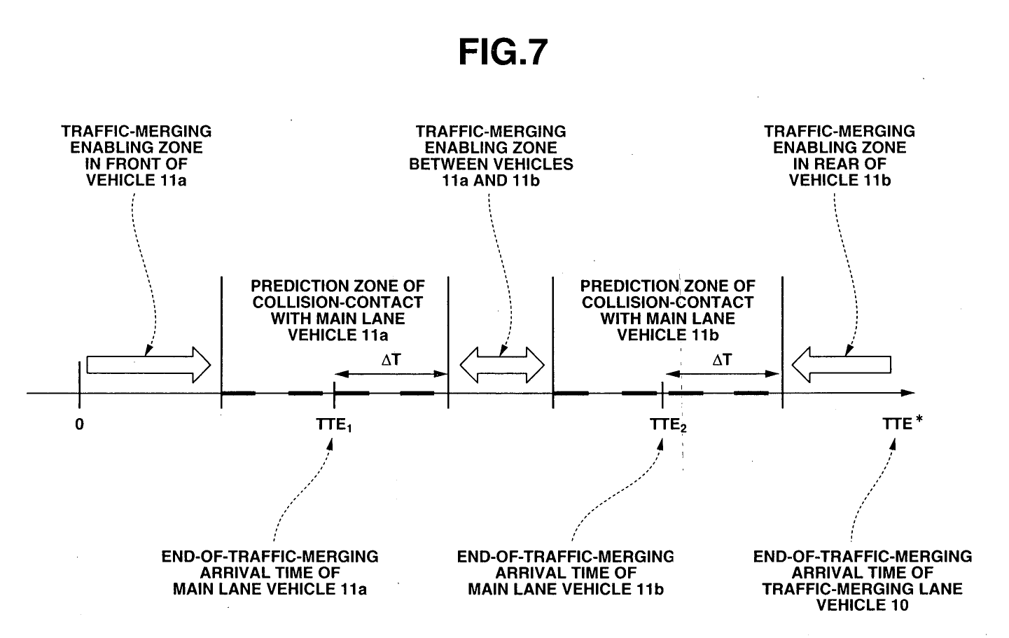

On the other hand, within manipulated variable decision section (manipulated variable decision means) 3f, a check is made to determine, based on the generated host vehicle's manipulated variable (exactly, the host vehicle's manipulated-variable time series data generated by the previously-noted host-vehicle manipulated variable setting section 3d), which of gaps of main lane 12 should be suited for an entry of the traffic-merging lane vehicle (host vehicle 10) into the main lane during the traffic-merging operation (during the lane-changing operation), when host vehicle 10 is operated in accordance with the generated host vehicle's manipulated variable. The above-mentioned gaps mean a plurality of vehicle-to-vehicle gaps defined between a group of vehicles traveling on the main lane into which the traffic-merging lane vehicle (host vehicle 10) is lane-changed during the traffic-merging operation. As a criterion for determining which of gaps of main lane 12 should be suited for an entry of the traffic-merging lane vehicle (host vehicle 10) into main lane 12, end-of-traffic-merging arrival times TTE₁ and TTE₂ of the main lane vehicles (first and second peripheral vehicles 11a and 11b), which arrival times are executed within peripheral vehicle behavior prediction section (peripheral vehicle behavior prediction means) 3c, are used. As previously described, in order to realize an appropriate entry of host vehicle 10 into main lane 12 during the traffic-merging operation, while avoiding the traffic-merging lane vehicle (host vehicle 10) from being brought into collision-contact with the main lane vehicle (either one of first and second peripheral vehicles 11a and 11b) at traffic-merging end x_{end}, the end-of-traffic-merging arrival time (desired end-of-traffic-merging arrival time TTE*) of the traffic-merging lane vehicle (host vehicle 10) must be spaced apart from each of end-of-traffic-merging arrival time TTE₁ of the first main lane vehicle (first peripheral vehicle 11a), and end-of-traffic-merging arrival time TTE₂ of the second main lane vehicle (second peripheral vehicle 11b). In the first situation shown in FIG. 3, the host vehicle's manipulated variable must be adjusted, so that the end-of-traffic-merging arrival time of host vehicle 10 and each of the end-of-traffic-merging arrival times TTE₁ and TTE₂ of first and second peripheral vehicles 11a and 11b are not so close to each other. As a reference needed to avoid undesirable collision contact between the main lane vehicle and the traffic-merging lane vehicle during the traffic-merging operation, the end-of-traffic-merging arrival time of the traffic-merging lane vehicle has to be spaced apart from that of the main lane vehicle by a predetermined reference time period ΔT. On the assumption that such a predetermined reference time period ΔT for collision-contact avoidance has been preset, as a criterion for determining the end-of-traffic-merging arrival time of host vehicle 10, the model of FIG. 7 showing the relationship between the end-of-traffic-merging arrival time and the traffic-merging enabling gap (or the lane-changing enabling gap) can be taken into consideration.

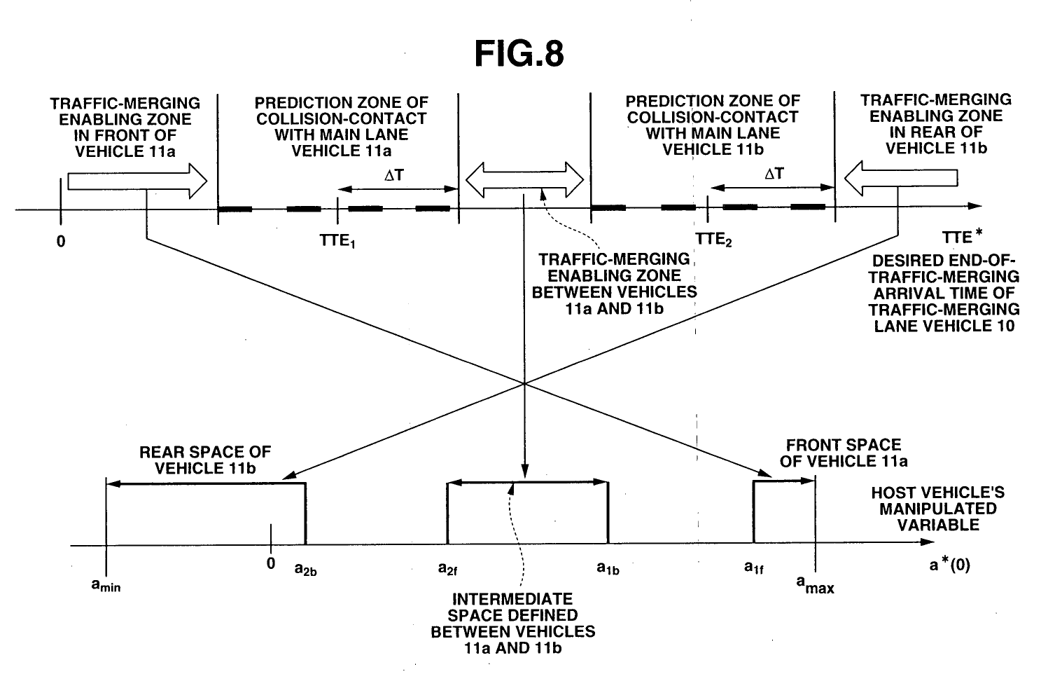

As previously described in referenced to each of FIGS. 4-6, host-vehicle manipulated variable setting section 3d generates the host vehicle's manipulated variable under a condition where the end-of-traffic-merging arrival time (desired end-of-traffic-merging arrival time TTE*) of host vehicle 10 has already been determined or designated or set. Thus, by the use of the criterion (the model shown in FIG. 7) for determining the end-of-traffic-merging arrival time of host vehicle 10, it is possible to correlate the host vehicle's manipulated variable directly with the traffic-merging enabling gap. Regarding the host vehicle's manipulated-variable time series data, generated by host-vehicle manipulated variable setting section 3d, a current manipulated variable a*(0) corresponding to a current value of desired host vehicle's acceleration, calculated at the current execution cycle, is most important. Therefore, it is important to determine a one-to-one correspondence between the current manipulated variable a*(0) of host vehicle 10 and the traffic-merging enabling gap (or the lane-changing enabling gap). By virtue of repeated executions of arithmetic and logic processing achieved by host-vehicle manipulated variable setting section 3d, as can be seen from the correspondence (mapping) between the current manipulated variable a*(0) and the traffic-merging enabling gap shown in FIG. 8, it is possible to convert the correspondence between the end-of-traffic-merging arrival time and the traffic-merging enabling gap into the one-to-one correspondence between the current manipulated variable a*(0) and the traffic-merging enabling gap. As can be appreciated from the mapping process of FIG. 8, suppose that time spans (time durations or time intervals) of desired end-of-traffic-merging arrival times TTE* respectively needed for (i) the host vehicle's entry into the front space of first peripheral vehicle 11a, (ii) the host vehicle's entry into the intermediate space defined between first and second peripheral vehicles 11a and 11b, and (iii) the host vehicle's entry into the rear space of second peripheral vehicle 11b are computed or calculated as follows.
0≦TTE*≦(TTE₁−ΔT)
(TTE₁+ΔT)≦TTE*≦(TTE₂−ΔT)
TTE*≧(TTE₂+ΔT)
The arithmetic and logic processing achieved by host-vehicle manipulated variable setting section 3d is applied to both ends of each of the calculated time spans [0≦TTE*≦(TTE₁−ΔT), (TTE₁+ΔT)≦TTE*≦(TTE₂−ΔT), and TTE*≧(TTE₂+ΔT)]. In other words, the arithmetic and logic processing achieved by host-vehicle manipulated variable setting section 3d is applied to each of boundary time points (that is, TTE*=0, TTE*=(TTE₁−ΔT), TTE*=(TTE₁+ΔT), TTE*=(TTE₂−ΔT), TTE*=(TTE₂+ΔT)) between each traffic-merging enabling time span [i.e., 0≦TTE*≦(TTE₁−ΔT), (TTE₁+ΔT)≦TTE*≦(TTE₂−ΔT), and TTE*≧(TTE₂+ΔT)] and each traffic-merging disabling time span [i.e., the collision-contact prediction zones, concretely, (TTE₁−ΔT)<TTE*<(TTE₁+ΔT) and (TTE₂−ΔT)<TTE*<(TTE₂+ΔT)], so as to derive or calculate initial values of the corresponding host vehicle's manipulated variable time series. In this manner, the correspondence between the end-of-traffic-merging arrival time and the traffic-merging enabling gap can be converted into the one-to-one correspondence between the current manipulated variable a*(0) and the traffic-merging enabling gap, and thus the three time spans of desired end-of-traffic-merging arrival times TTE* are indicated or mapped on the desired host vehicle's manipulated variable a*(0)-coordinate axis (see the lower half of FIG. 8), respectively as follows.
a_{1f}≦a*(0)≦aₘₐₓ
a_{2f}≦a*(0)≦a_{1b}
aₘᵢₙ≦a*(0)≦a_{2b}
By way of such a mapping process, it is possible to clearly define or clarify the relationship between the current value of the host vehicle's manipulated variable and the appropriate traffic-merging behavior (or the appropriate lane-changing behavior) of host vehicle 10 into main lane 12. That is, it is possible to more suitably accurately specify or designate a traffic-merging enabling gap, which can be predicted or determined based on the current level of the host vehicle's manipulated variable (that is, the current host vehicle acceleration). In other words, in case that the appropriate traffic-merging enabling gap has already been determined, the driver can obtain information on the host vehicle's manipulated variable suited for the traffic-merging operation. The previously-discussed processing (containing the mapping process) to derive or compute the correspondence between the host vehicle's manipulated variable and the traffic-merging enabling gap corresponds to arithmetic and logic processing of manipulated variable decision section (manipulated variable decision means) 3f.

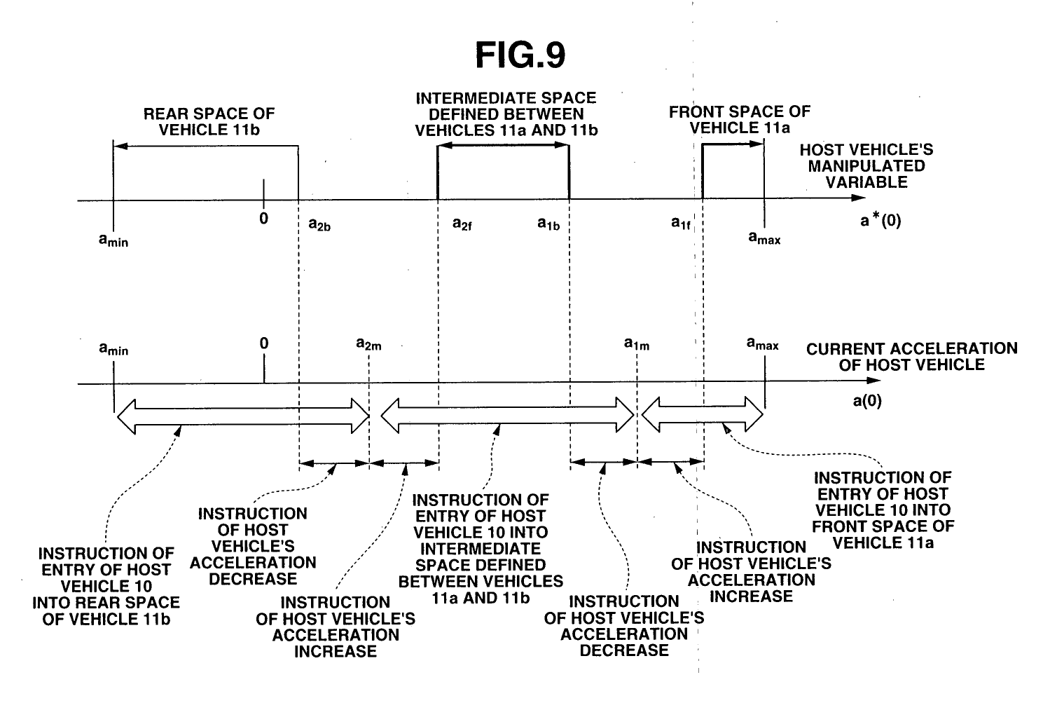

A main role of support information presentation section (support information presentation means) 4 is to more properly process the information on the correspondence (mapping) shown in FIG. 8 in an easy style and to transmit the easily understandable, processed information (see FIG. 9) to the driver. For instance, in order to realize a function that transmits a more appropriate traffic-merging enabling gap to the driver, the current host vehicle acceleration (corresponding to the current driver's manipulated variable) must be evaluated on the desired host vehicle's manipulated variable a*(0)-coordinate axis produced by manipulated variable decision section 3f (see FIG. 8). The more appropriate traffic-merging enabling gap corresponds to such a gap that appropriate traffic-merging operation of host vehicle 10 can be attained with a minimum change (in other words, a minimum vehicle acceleration change) in the current manipulated variable (serving as a reference). FIG. 9 shows the concrete example of the properly processed result, which is obtained by properly processing the correspondence (mapping) between the current manipulated variable a*(0) and the traffic-merging enabling gap shown in FIG. 8 and generated by manipulated variable decision section 3f. The properly processed result (the properly processed correspondence between the current manipulated variable a*(0) and the traffic-merging enabling gap) is generated by support information presentation section 4, for easily clearly evaluating the current host vehicle acceleration by utilizing the desired host vehicle's manipulated variable a*(0)-coordinate axis. Assuming that the current host vehicle acceleration a(0) is within either one of the appropriate traffic-merging enabling manipulated variable ranges (that is, the traffic-merging enabling vehicle acceleration ranges, namely, a_{1f}≦a*(0)≦aₘₐₓ, a_{2f}≦a*(0)≦a_{1b}, and aₘᵢₙ≦a*(0)≦a_{2b}) corresponding to the respective gaps, in the system of the first embodiment, support information presentation section 4 (display device 4a) is allowed to display support information regarding the traffic-merging operation (the entry) of host vehicle 10 into the corresponding gap correlated with the one traffic-merging enabling manipulated variable range in which the current host vehicle acceleration is included. On the contrary, when the current host vehicle acceleration a(0) is out of either one of the appropriate traffic-merging enabling manipulated variables (that is, the traffic-merging enabling vehicle acceleration ranges, namely, a_{1f}≦a*(0)≦aₘₐₓ, a_{2f}≦a*(0)≦a_{1b}, and aₘᵢₙ≦a*(0)≦a_{2b}) corresponding to the respective gaps, in other words, when the current host vehicle acceleration a(0) is within either one of the traffic-merging disabling manipulated variables (that is, the traffic-merging disabling vehicle acceleration ranges (collision-contact prediction zones), namely, a_{2b}<a*(0)<a_{2f} and a_{1b}<a*(0)<a_{1f}, the system of the first embodiment has to determine or select an appropriate gap (a lane-changing enabling gap) correlated with such an appropriate traffic-merging enabling manipulated variable range (such a traffic-merging enabling vehicle acceleration range), which can be reached by the minimum manipulated-variable compensation, and also to display information regarding the traffic-merging operation (the entry) of host vehicle 10 into the corresponding gap correlated with the selected traffic-merging enabling manipulated variable range. Assuming that two or more gaps are simultaneously determined as lane-changing enabling gaps by manipulated variable decision section 3f, support information presentation section 4 selects the foremost gap of these lane-changing enabling gaps. At the same time, the system has to display support information regarding a host vehicle acceleration increase/decrease needed for the traffic-merging operation (the entry) of host vehicle 10 into the corresponding gap correlated with the selected traffic-merging enabling manipulated variable. In case of the example shown in FIG. 9, there are the following seven classified current host vehicle's acceleration ranges, in other words, the following seven different support information display patterns (1)-(7).

(1) When aₘᵢₙ≦a(0)≦a_{2b}, as a first display pattern, support information presentation section 4 (display device 4a) displays information regarding an entry (a traffic-merging operation) of host vehicle 10 into the rear space of second peripheral vehicle 11b.

(2) When a_{2b}<a(0)≦a₂ₘ, as a second display pattern, support information presentation section 4 displays information regarding an entry (a traffic-merging operation) of host vehicle 10 into the rear space of second peripheral vehicle 11b, and simultaneously displays information on a decrease in the host vehicle's acceleration.

(3) When a₂ₘ<a(0)<a_{2f}, as a third display pattern, support information presentation section 4 displays information regarding an entry (a traffic-merging operation) of host vehicle 10 into the intermediate space defined between first and second peripheral vehicles 11a and 11b, and simultaneously displays information on an increase in the host vehicle's acceleration.

(4) When a_{2f}≦a(0)≦a_{1b}, as a fourth display pattern, support information presentation section 4 displays information regarding an entry (a traffic-merging operation) of host vehicle 10 into the intermediate space of first and second peripheral vehicles 11a and 11b.

(5) When a_{1b}<a(0)≦a₁ₘ, as a fifth display pattern, support information presentation section 4 displays information regarding an entry (a traffic-merging operation) of host vehicle 10 into the intermediate space of first and second peripheral vehicles 11a and 11b, and simultaneously displays information on a decrease in the host vehicle's acceleration.

(6) When a₁ₘ<a(0)<a_{1f}, as a sixth display pattern, support information presentation section 4 displays information regarding an entry (a traffic-merging operation) of host vehicle 10 into the front space of first peripheral vehicle 11a, and simultaneously displays information on an increase in the host vehicle's acceleration.

(7) When a_{1f}≦a(0)≦aₘₐₓ, as a seventh display pattern, support information presentation section 4 (display device 4a) displays information regarding an entry (a traffic-merging operation) of host vehicle 10 into the front space of first peripheral vehicle 11a.

The previously-discussed acceleration value a₂ₘ is a decision boundary value set midway between the traffic-merging disabling vehicle acceleration range |a_{2b}, a_{2f}|, whereas the previously-discussed acceleration value a₁ₘ is a decision boundary value set midway between the traffic-merging disabling vehicle acceleration range |a_{1b}, a_{1f}|. For instance, the decision boundary value a₂ₘ can be determined or set as a simple mean of the two acceleration values a_{2b} and a_{2f}, that is, a₂ₘ=a_{2b}+a_{2f}, whereas the decision boundary value a₁ₘ can be determined or set as a simple mean of the two acceleration values a_{1b} and a_{1f}, that is, a₁ₘ=a_{1b}+a_{1f}.

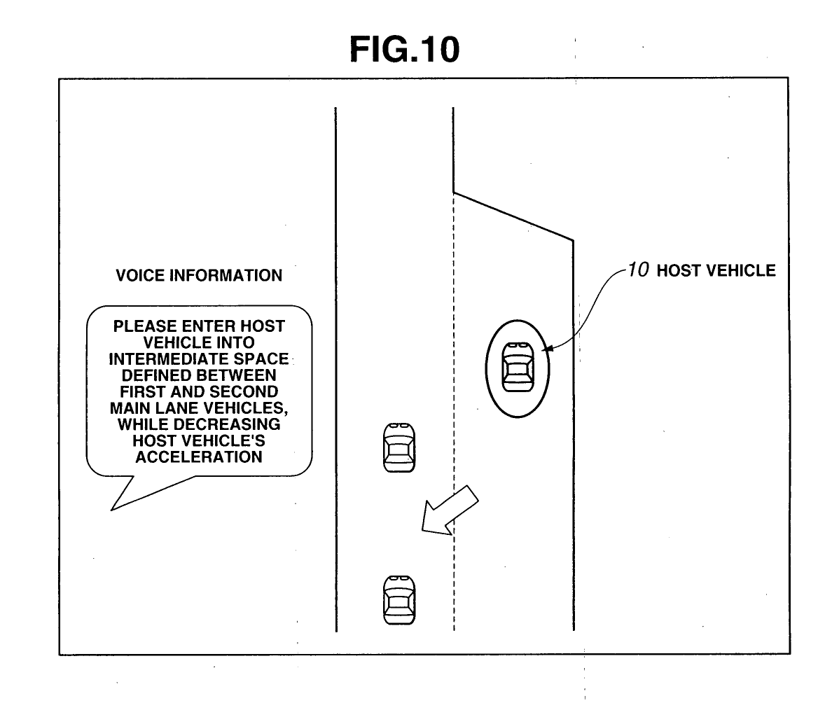

Referring now to FIG. 10, there is shown one example of the method to display or present support information by support information presentation section 4. For instance, assuming that the current host vehicle acceleration a(0) corresponds to the fifth display pattern (5), that is, a_{1b}<a(0)≦a₁ₘ, as shown in FIG. 10, a marker, which points out the gap (the intermediate space defined between first and second peripheral vehicles 11a and 11b), is displayed on display device 4a (see the voided arrow of FIG. 10). At the same time, the support information on both of a decrease in host vehicle acceleration and an entry (a traffic-merging operation) of host vehicle 10 into the intermediate space of first and second peripheral vehicles 11a and 11b, is audibly indicated. Information about the current acceleration value of host vehicle 10 can be sensed or measured directly by an acceleration sensor (a G sensor) mounted on host vehicle 10. Instead of directly using a sensor signal from the G sensor, the speed data of host vehicle 10 may be processed through a differentiation filter. In this case, a host vehicle's acceleration value can be arithmetically calculated as a differentiated value, that is, a time rate of change in the host vehicle's speed data. Alternatively, the host vehicle acceleration may be estimated based on the engine and power-train information, such as a throttle opening, engine speed, and a transmission ratio.

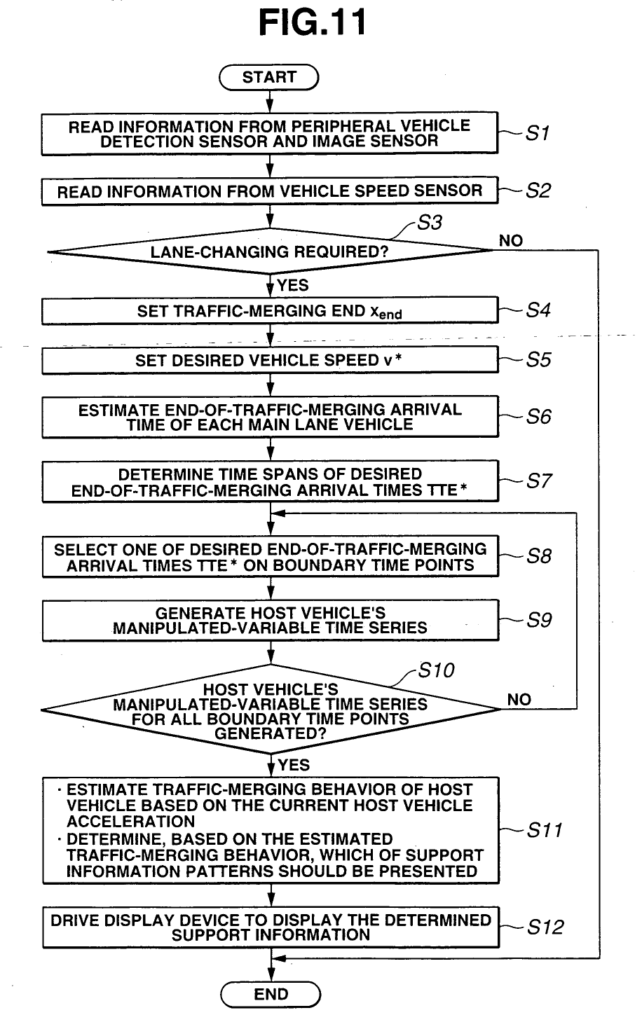

Referring now to FIG. 11, there is shown the lane-changing support routine (or the traffic-merging support routine) executed by the system of the first embodiment. The routine of FIG. 11 is executed as time-triggered interrupt routines to be triggered every predetermined time intervals.

At step S1, input information from peripheral sensors 1a, 1b, 1c, 1d, and 1d, all constructing peripheral vehicle detection sensor (peripheral vehicle detection means) 1 and image sensor 1b constructing lane detection section (lane detection means) 7 is read. That is, information on both of the relative position and relative speed of the main lane vehicle traveling on main lane 12 with respect to the traffic-merging lane vehicle (host vehicle 10), is read.

At step S2, information from vehicle speed sensor 2a, constructing host-vehicle driving-state detection section (host-vehicle driving-state detection means) 2, is read. That is, the current driving state of host vehicle 10, concretely, the current host vehicle speed is detected.

At step S3, the current three-dimensional position of host vehicle 10 is determined based on the GPS signal received by GPS signal receiving unit 5. At the same time, the current traveling road of host vehicle 10 is identified by collating the current host vehicle's position estimated or calculated by GPS signal receiving unit 5 with road map information on the road networks stored in map information database 6. On the basis of the information about the current three-dimensional position of host vehicle 10 and the current traveling road of host vehicle 10, a check is made to determine whether a traffic-merging point (a lane-changing point) exists ahead of host vehicle 10. In other words, a check is made, based on information on both of the current host vehicle's three-dimensional position and the current traveling road, to determine whether there is a necessity of lane-changing operation of host vehicle 10. When the answer to step S3 is in the affirmative (YES), that is, when a traffic-merging point (a lane-changing point) exists ahead of host vehicle 10 and thus there is a necessity of lane-changing operation of host vehicle 10, the routine proceeds from step S3 to step S4. Conversely when the answer to step S3 is in the negative (NO), that is, when there is no necessity of lane-changing operation of host vehicle 10, the system determines that there is no necessity of presentation of support information, and thus the current execution cycle terminates.

At step S4, traffic-merging end x_{end} is set to an arbitrary position before the traffic-merging point.

At step S5, desired vehicle speed v* (a desired traffic-merging speed) of a point of time at which host vehicle 10 reaches traffic-merging end x_{end}, determined through step S4, is set or determined based on the main lane vehicle's speeds (first and second peripheral vehicle speeds) v₁ and v₂ (see the previously-discussed expressions (16) or (17)).

At step S6, end-of-traffic-merging arrival time TTE₁ of the first main lane vehicle (first peripheral vehicle 11a) and end-of-traffic-merging arrival time TTE₂ of the second main lane vehicle (second peripheral vehicle 11b) are estimated or arithmetically calculated (see the previously-discussed expression (1)).

At step S7, traffic-merging enabling time spans (simply, time spans) of desired end-of-traffic-merging arrival times TTE*, each time span permitting a smooth traffic-merging operation (a smooth entry) of host vehicle 10 into main lane 12 without any collision-contact between the traffic-merging lane vehicle (host vehicle 10) and the main lane vehicle (each of first and second peripheral vehicles 11a and 11b), are set or determined based on calculated end-of-traffic-merging arrival times TTE₁ and TTE₂ of main lane vehicles 11a and 11b (see the model shown in FIG. 7).

At step S8, of these desired end-of-traffic-merging arrival time spans set through step S7, one of boundary time points [that is, one of desired end-of-traffic-merging arrival times on the respective boundary time points, concretely, TTE*=0, TTE*=(TTE₁−ΔT), TTE*=(TTE₁+ΔT), TTE*=(TTE₂−ΔT), and TTE*=(TTE₂+ΔT)} between the two adjacent traffic-merging enabling and disabling time spans is selected.

At step S9, the arithmetic and logic processing of host-vehicle manipulated variable setting section 3d is executed with respect to the desired value pair, that is, the selected boundary time point determined through step S8 (i.e., the selected desired end-of-traffic-merging arrival time TTE*) and the desired vehicle speed v* set through step S5, so as to calculate an initial value of host vehicle's manipulated-variable time series that satisfies these condition (desired end-of-traffic-merging arrival time TTE* selected at step S8 and desired vehicle speed v* set at step S5). Additionally, the initial value of host vehicle's manipulated variable time series is correlated with the host vehicle's desired end-of-traffic-merging arrival time. In this manner, as seen from the lower half of FIG. 8, the correspondence between the host vehicle's end-of-traffic-merging arrival time and the traffic-merging enabling gap can be converted into the one-to-one correspondence between the current manipulated variable a*(0) and the traffic-merging enabling gap.

At step S10, a check is made to determine whether the host vehicle's manipulated-variable time series data for all of the boundary time points (that is, TTE*=0, TTE*=(TTE₁−ΔT), TTE*=(TTE₁+ΔT), TTE*=(TTE₂−ΔT), and TTE*=(TTE₂+ΔT)) on the desired end-of-traffic-merging arrival time TTE*-coordinate axis have been generated. When the answer to step S10 is negative (NO), that is, when the host vehicle's manipulated-variable time series data for all boundary time points on the desired end-of-traffic-merging arrival time TTE*-coordinate axis have not yet been generated, the routine returns from step S10 to step S8. On the contrary, when the answer is affirmative (YES), that is, when the host vehicle's manipulated-variable time series data for all boundary time points on the desired end-of-traffic-merging arrival time TTE*-coordinate axis have already been generated, the routine proceeds from step S10 to step S11.

At step S11, by reference to the correspondence between the initial value of host vehicle's manipulated variable time series generated through step S9 and the host vehicle's desired end-of-traffic-merging arrival time, the traffic-merging behavior of host vehicle 10 can be estimated or predicted based on the current host vehicle's manipulated variable (i.e., the current host vehicle's acceleration). The system of the first embodiment determines, based on the estimated traffic-merging behavior of host vehicle 10, which of support information patterns should be presented. In the system of the first embodiment, in accordance with the previously-discussed rule shown in FIG. 9, the optimum support information pattern is determined.

At step S12, the support information determined through step S11 is displayed and presented by means of support information presentation section 4 (display device 4a), so as to inform the driver of the optimum support information. In the shown embodiment, as can be seen from the display method of FIG. 10, the optimum support information is presented to the driver audibly and visually.

As explained above, the lane-changing support system (the traffic-merging support system) of the first embodiment includes host-vehicle driving-state detection section (host-vehicle driving-state detection means) 2 that detects the vehicle driving state of host vehicle 10, peripheral vehicle detection section (peripheral vehicle detection means) 1 that detects peripheral vehicles, and lane detection section (lane detection means) 7 that detects a lane marking (an on-road white line around host vehicle 10). The lane-changing support system (the traffic-merging support system) of the first embodiment also includes end-of-traffic-merging setting section (end-of-traffic-merging setting means) 3b that sets traffic-merging end x_{end} at which lane-changing operation (traffic-merging operation) of host vehicle 10 has to be completed, peripheral vehicle behavior prediction section (peripheral vehicle behavior prediction means) 3c that predicts or estimates the driving behavior of each peripheral vehicle, and host-vehicle manipulated variable setting section (host-vehicle manipulated variable setting means) 3d that generates at least one manipulated-variable time series to be executed during a time period from a time when the system determines that there is a necessity for lane-changing to a time when host vehicle 10 reaches the estimated traffic-merging end x_{end} (the assumed traffic-merging end or the hypothetical traffic-merging end). Also provided is manipulated variable decision section (manipulated variable decision means) 3f that determines whether a proper lane-changing operation (or a proper traffic-merging operation) can be achieved when executing the manipulated-variable time series, generated by host-vehicle manipulated variable setting section (host-vehicle manipulated variable setting means) 3d, and additionally determines which of gaps defined between peripheral vehicles traveling on the traffic lane of destination of lane-changing should be suited for an entry of host vehicle 10 when there is a high possibility of the proper lane-changing operation. The system of the first embodiment further includes support information presentation section (support information presentation means) 4 that transmits information regarding the correspondence between the current manipulated variable a*(0) on the manipulated-variable time series manipulated variable decision section 3f and each traffic-merging enabling gap (each lane-changing enabling gap) determined or computed by manipulated variable decision section (manipulated variable decision means) 3f, to the driver. As discussed above, end-of-traffic-merging setting section (end-of-traffic-merging setting means) 3b is designed to estimate or set a traffic-merging completion point (traffic-merging end x_{end}) at which lane-changing operation (traffic-merging operation) of host vehicle 10 has to be completed. Thus, even in a specific traffic situation that host vehicle 10 cannot be kept within the current driving lane owing to a traffic environment, the system can generate and present optimum support information on lane-changing, while taking the specific traffic situation into consideration. Additionally, a decision executed within manipulated variable decision section (manipulated variable decision means) 3f is made in a manner such that the host vehicle's manipulated variable is correlated directly with the traffic-merging enabling gap (or the lane-changing enabling gap). The support system of the first embodiment can present or display a wholly intuitively understandable target, for example, information on which of gaps should be suited for an entry of host vehicle 10 during lane-changing. Thus, there is no necessity that actions taken by the driver successively must follow undesirably many complicated commands. As set forth above, the support system of the first embodiment can support smooth lane-changing operation or smooth traffic-merging operation of host vehicle 10.

On the other hand, the traffic merging support system disclosed in JP10-105884 is designed to support and realize smooth traffic-merging operation by displaying information about a main-lane vehicle speed guidance, a traffic-merging lane vehicle speed guidance, a proper traffic-merging timing for the traffic-merging lane vehicle, and relative position information of a peripheral vehicle relative to a host vehicle via vehicle-mounted display devices. However, in the system disclosed in JP10-105884, an arithmetic and logic processing system needed to generate the displayed information is mounted on a highway as a roadside processing system rather than a vehicle-mounted processing system. Such a roadside processing system fixedly mounted on the highway is applicable to only a specific situation that lane-changing must be made owing to a road structure such as a gradually-narrowing traffic-merging area. On the contrary, the support system of the first embodiment can be widely applied even in any situations that there is a necessity of lane-changing of host vehicle 10 regardless of road structures, since the support system of the shown embodiment is constructed as a vehicle-mounted support system rather than a roadside support system. Therefore, the vehicle-mounted support system of the shown embodiment can support smooth traffic-merging operation or smooth lane-changing operation in broader traffic situations.

In addition to the above, peripheral vehicle behavior prediction section (peripheral vehicle behavior prediction means) 3c predicts end-of-traffic-merging arrival times TTE₁ and TTE₂ of peripheral vehicles 11a and 11b traveling on the traffic lane of destination of lane-changing, while manipulated variable decision section (manipulated variable decision means) 3f makes a decision on whether or not lane-changing of host vehicle 10 can be achieved appropriately, by comparing the estimated end-of-traffic-merging arrival time (desired end-of-traffic-merging arrival time TTE*) of host vehicle 10 to each of end-of-traffic-merging arrival times TTE₁ and TTE₂ of peripheral vehicles traveling on the traffic lane of destination of lane-changing. In this manner, the system of the shown embodiment determines an appropriateness of lane-changing based on a unified, simple criterion or a unified, simple reference, that is, end-of-traffic-merging arrival times TTE*, TTE₁, and TTE₂ at which respective vehicles 10, 11a, and 11b reach the same estimated traffic-merging end x_{end}. Thus, irrespectively of the number of peripheral vehicles traveling on the traffic lane of destination of the host vehicle's lane-changing, it is possible to easily precisely determine, estimate, detect or find out a lane-changing enabling gap (a traffic-merging enabling gap) into which host vehicle can enter appropriately without any collision-contact between host vehicle 10 and each peripheral vehicle, by way of repeated executions of the same arithmetical and logical process.

Furthermore, the system of the first embodiment includes desired vehicle speed setting section (desired vehicle speed setting means) 3e that sets or determines desired vehicle speed v* (the host vehicle's traffic-merging speed) to be attained until host vehicle 10 reaches traffic-merging end x_{end}. Host-vehicle manipulated variable setting section 3d is designed to generate such a host vehicle's manipulated-variable time series that desired vehicle speed v* set by desired vehicle speed setting section 3e is reached at traffic-merging end x_{end}. As discussed above, the host vehicle speed, which may be obtained when host vehicle 10 reaches traffic-merging end x_{end}, is taken into account. Therefore, it is possible to generate the realistic host vehicle's manipulated-variable time series according to which host vehicle 10 can be accelerated up to a vehicle speed value that an entry of host vehicle 10 into the traffic lane of destination of lane-changing is completed appropriately before arrival of host vehicle 10 at traffic-merging end x_{end}, even in a traffic situation that host vehicle 10 has to be adequately accelerated until the host vehicle reaches a traffic-merging point, for example, during the host vehicle's driving on a guide-path of a highway-interchange.

Additionally, host-vehicle manipulated variable setting section 3d is designed to generate such a host vehicle's manipulated-variable time series that desired vehicle speed v* set by desired vehicle speed setting section 3e is reached at traffic-merging end x_{end}, and additionally host vehicle 10 is timed to reach or arrive at traffic-merging end x_{end} at the desired end-of-traffic-merging arrival time TTE*. That is, host-vehicle manipulated variable setting section 3d is designed to generate the host vehicle's manipulated-variable time series in a manner such that desired end-of-traffic-merging arrival time TTE* and desired vehicle speed v* set by desired vehicle speed setting section 3e, are both satisfied. Within manipulated variable decision section 3f, a candidate of a host vehicle's manipulated variable for manipulated-variable decision is specified or designated in terms of an end-of-traffic-merging arrival time. As set forth above, desired end-of-traffic-merging arrival time TTE* of host vehicle 10 is used as input data of host-vehicle manipulated variable setting section 3d. Thus, it is possible to directly correlate the host vehicle's manipulated variable with the traffic-merging enabling gap (or the lane-changing enabling gap) via the end-of-traffic-merging arrival time, and whereby it is possible to anticipatively generate optimum support information.

Desired vehicle speed setting section 3e is designed to set or determine desired vehicle speed v* of host vehicle 10, taking into account peripheral vehicle speeds v₁ and v₂ of peripheral vehicles 11a and 11b traveling on the traffic lane of destination of lane-changing. Thus, even when there is a remarkable speed difference between the host vehicle speed and the peripheral vehicle speed of each peripheral vehicle traveling on the traffic lane of destination of lane-changing, the support system of the shown embodiment can generate the realistic host vehicle's manipulated-variable time series according to which the remarkable speed difference can be effectively compensated for or reduced to below an acceptable level until initiation of lane-changing operation of host vehicle 10.

The system of the first embodiment also includes lane-changing necessity decision section (lane-changing necessity decision means) 3a that autonomously makes a decision on a necessity of lane-changing and a traffic lane of destination of lane-changing. Thus, only during a time period during which lane-changing necessity decision section 3a determines that there is a necessity of lane-changing, the system repeatedly executes arithmetic and logic processes and displaying action for support information on host vehicle's lane-changing to the traffic lane of destination. As discussed above, lane-changing necessity decision section 3a is designed to autonomously make a decision on a necessity of lane-changing without any instruction by the driver, to automatically begin to present or display optimum support information. Thus, even under a state where the driver does not yet take notice of a necessity of lane-changing, the system of the shown embodiment can inform the driver of optimum operations of host vehicle 10, that is, optimum host vehicle acceleration/deceleration, optimum lane-changing timing (optimum traffic-merging timing) and lane-changing enabling gap (traffic-merging enabling gap), while predicting or estimating a future traffic situation.

Moreover, lane-changing necessity decision section 3a is designed to determine that there is a necessity of lane-changing of host vehicle 10, when a current host vehicle's driving lane is merged into a traffic lane closely juxtaposed to the current host vehicle's driving lane at a traffic-merging point ahead of host vehicle 10. On the other hand, end-of-traffic-merging setting section 3b is designed to set traffic-merging end x_{end} as an arbitrary position, which is located upstream of a lane-termination point that the current host vehicle's driving lane physically completely vanishes into nothing, and spaced apart from the lane-termination point by a predetermined distance. As discussed above, the system of the first embodiment is designed to make a decision on a necessity of lane-changing by automatically detecting a point, which requires lane-changing operation and whose traffic-lane width gradually narrows, for example, a guide-path of a highway-interchange, a guide-path of a highway service area, and the like. Thus, the system of the first embodiment can present or display optimum support information when host vehicle 10 approaches such a point that requires lane-changing operation owing to a traffic-merging area.

Support information presentation section 4 is designed to inform the driver of optimum support information regarding which of vehicle-to-vehicle gaps of a traffic lane of destination of lane-changing should be selected as lane-changing enabling gaps each permitting an appropriate entry of host vehicle 10 into the traffic lane of destination with a minimum change in the current driver's manipulated variable (serving as a reference) made to host vehicle 10. In this manner, the system of the first embodiment selects at least one more-preferable gap from the plural gaps of the traffic lane of destination of lane-changing, taking the current driver's manipulated variable (the current host vehicle acceleration) into consideration, and then transmits information on the selected gap to the driver. Thus, the system of the first embodiment can present a recommended lane-changing pattern to meet the driver's wishes (in other words, the current host vehicle acceleration/deceleration).

When two or more gaps are simultaneously determined as lane-changing enabling gaps by manipulated variable decision section 3f, support information presentation section 4 selects the foremost gap of these lane-changing enabling gaps, and to inform the driver of the selected foremost gap. By way of selection of the foremost gap of lane-changing enabling gaps, it is possible to provide support information that satisfies or meets the general driver's wishes, that is, a positive host vehicle's entry into a space ahead of the peripheral vehicle.

Support information presentation section 4 is also designed to inform the driver of optimum support information on whether host vehicle 10 should be accelerated or decelerated from the current host vehicle speed, in order to realize an appropriate lane change (an appropriate entry) of host vehicle 10 into the lane-changing enabling gap or the traffic-merging enabling gap. In this manner, the driver is informed of the optimum host vehicle's manipulated variable (required vehicle acceleration/deceleration) needed for lane-changing, as well as the lane-changing enabling gap, and therefore the easily-understandable, displayed information (the displayed contents) is very helpful for concrete actions to be taken by the driver.

Support information presentation section 4 is equipped with or data-linked to map information database 6, which serves as a peripheral map drawing section (a peripheral map drawing means) that plots or draws a peripheral map (a peripheral-vehicle map) indicative of a layout of peripheral vehicles 11a and 11b, based on a sensor signal from peripheral vehicle detection section 1, on display device 4a. Support information presentation section 4 is designed to inform the driver of the decision result on lane-changing support by overwriting at least on of a first marker, which points out the selected lane-changing enabling gap, and a second marker, which indicates information on a host vehicle acceleration change (an acceleration increase/decrease) needed for an appropriate lane change (an appropriate entry) of host vehicle 10 into the selected lane-changing enabling gap, on the displayed peripheral map. In this manner, it is possible to transmit support information processed as a wholly intuitively understandable visual data to the driver by overwriting the selected lane-changing enabling gap on the displayed peripheral map.

Additionally, support information presentation section 4 is designed to inform the driver of the decision result on lane-changing support by audibly instructing and guiding support information on both of (i) the selected optimum gap, which is selected as an optimum one from the lane-changing enabling gaps by means of support information presentation section 4, and (ii) required host vehicle's manipulation to be taken by the driver for the appropriate lane change of host vehicle 10 into the selected optimum gap. In this manner, it is possible to inform the driver of optimum support information without turning the driver's eyes away from the outside of the host vehicle. Thus, it is possible to effectively (audibly) provide optimum support information even under a situation where the driver cannot afford to shift his (her) view point toward the support information display device.

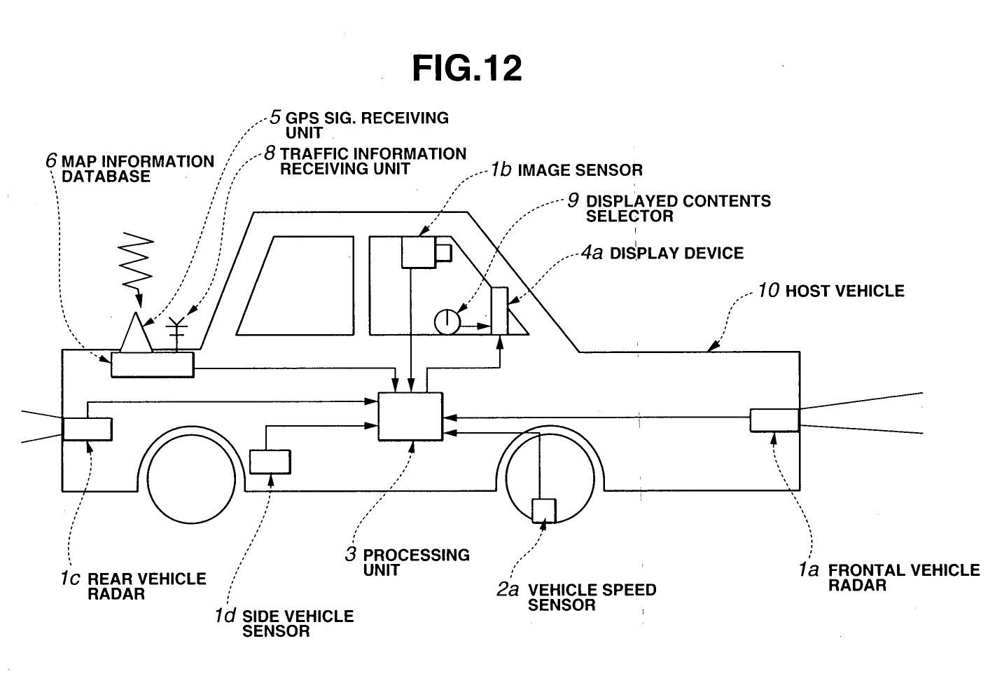

Referring now to FIGS. 12-16, there is shown the lane-changing support system of the second embodiment. FIG. 12 shows the schematic layout of components constructing the lane-changing support system of the second embodiment. The basic components of the system of the second embodiment are identical to those (1a, 1b, 1c, 1d, 1d, 2a, 3, 4a, 5, and 6) of the first embodiment. The system of the second embodiment further includes a traffic information receiving unit 8 and a displayed contents selector 9. Traffic information receiving unit 8 is provided to receive traffic information. Displayed contents selector 9 is comprised of a dial switch 17 by which contents to be displayed on display device 4a are manually selected.

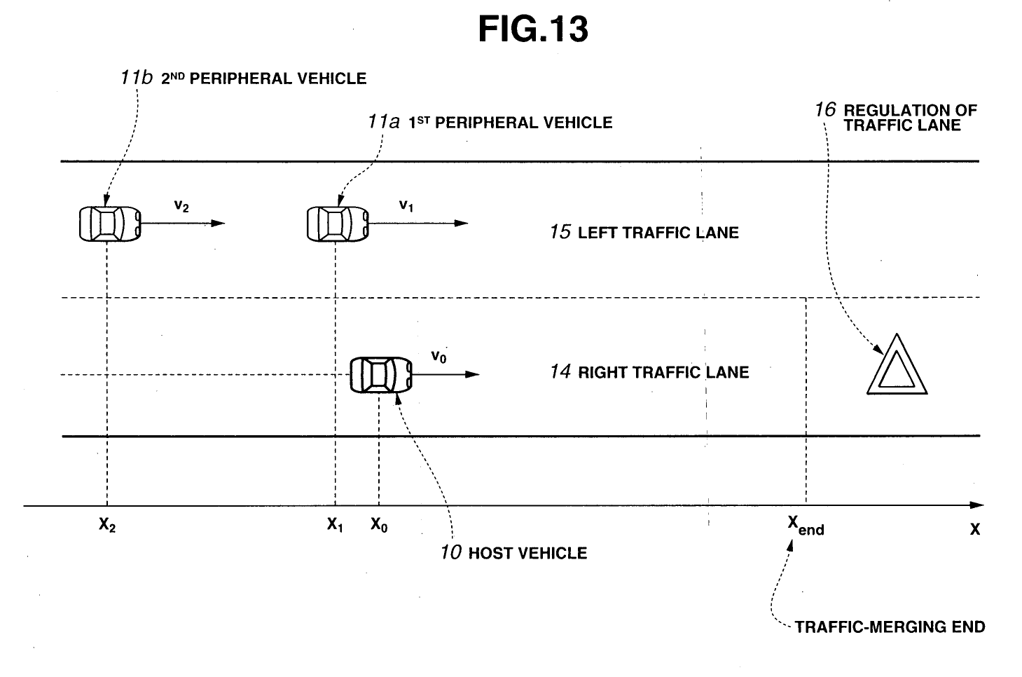

Support information processing executed by the system of the second embodiment is hereunder described in reference to the second traffic situation shown in FIG. 13. FIG. 13 shows the second traffic situation in which one half of the highway is constructed by two lanes 14 and 15, the right traffic lane 14 of the two lanes is regulated ahead of host vehicle 10, traveling on right traffic lane 14, owing to a traffic-lane regulation 16 such as road repairs or road construction work, and other vehicles, namely first and second peripheral vehicles 11a and 11b, both travel on the left traffic lane 15. In the second traffic situation, host vehicle 10 cannot be kept within the current driving lane (right traffic lane 14) owing to such a traffic-lane regulation 16. That is, in the second traffic situation, lane-changing operation of host vehicle 10 from right traffic lane 14 to left traffic lane 15 must be made. In the second traffic situation of FIG. 13, the arithmetic and logic processes executed by processing unit 3 incorporated in the system of the second embodiment are substantially identical to those of the system of the first embodiment. Thus, the arithmetic and logic processes achieved by processing unit 3 of the system of the second embodiment are executed substantially in accordance with the support information processing program as shown in FIG. 11. The arithmetic and logic processing of the system of the second embodiment (FIGS. 12-16) is somewhat different from that of the first embodiment (FIGS. 1-11), in that in the system of the second embodiment a decision process for determining the necessity of lane-changing at step S3 is performed, while taking into account information on traffic-lane regulation 16, which can be received by traffic information receiving unit 8. For instance, the logic circuit of processing unit 3 of the system of the second embodiment determines that there is a necessity of lane-changing, when a distance between host vehicle 10 and a starting point where traffic-lane regulation 16 starts becomes less than or equal to a predetermined distance such as 500 meters and additionally host vehicle 10 travels on the traffic lane of traffic-lane regulation 16.

When the logic circuit of processing unit 3 determines that there is a necessity of lane-changing, the routine proceeds from step S3 to step S4. At step S4, traffic-merging end x_{end} is set to an arbitrary position before the starting point where traffic-lane regulation 16 starts.

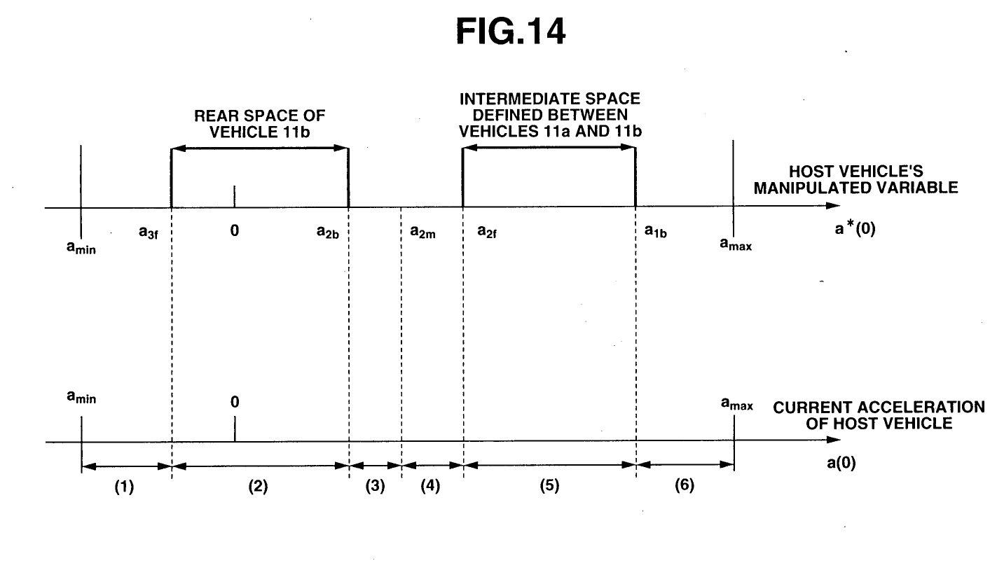

Regarding detailed contents of arithmetic and logic processes executed after traffic-merging end x_{end} has been set, the lane-changing support procedure made by the system of the second embodiment is mathematically or algorithmically identical to the traffic-merging support procedure made by the system of the first embodiment. Thus, within the processing unit of the system of the second embodiment, after the decision process of step S4, the same processes as steps S5-S11 shown in FIG. 11 are executed. FIG. 14 shows the concrete example of the properly processed result (the properly processed correspondence between the current manipulated variable a*(0) and the traffic-merging enabling gap), generated by support information presentation section 4, for easily clearly evaluating the current host vehicle acceleration by utilizing the desired host vehicle's manipulated variable a*(0)-coordinate axis. In the system of the second embodiment, as a result of the processes of steps S1-S11, the correspondence shown in FIG. 14 has been obtained. In the system of the second embodiment somewhat different from the first embodiment, in other words, in the second traffic situation (in case of lane-changing owing to traffic-lane regulation) different from the first traffic situation (in case of traffic-merging owing to the traffic-merging area), there is an increased tendency for desired vehicle acceleration a*(0) to exceed upper acceleration limit aₘₐₓ, if host vehicle 10 tries to enter the front space of first peripheral vehicle 11a during the lane-changing period. If the calculated desired vehicle acceleration a*(0) exceeds upper acceleration limit aₘₐₓ, the system of the second embodiment determines that it is impossible to accomplish the desired value computed (that is, the manipulated variable a*(0) computed). For this reason, the front space of first peripheral vehicle 11a cannot be set as a lane-changing enabling zone. Thus, in FIG. 14, the front space of first peripheral vehicle 11a is canceled. In case of the concrete example shown in FIG. 14, there are the following six classified current host vehicle's acceleration ranges, in other words, the following six different support information patterns (1)-(6).

(1) When aₘᵢₙ≦a(0)≦a_{3f}, as a first display pattern, support information presentation section 4 (display device 4a) displays information regarding an entry (a lane-changing operation) of host vehicle 10 into the rear space of second peripheral vehicle 11b, and simultaneously displays information regarding an increase in the host vehicle's acceleration.

(2) When a_{3f}<a(0)≦a_{2b}, as a second display pattern, support information presentation section 4 (display device 4a) displays information regarding an entry (a lane-changing operation) of host vehicle 10 into the rear space of second peripheral vehicle 11b.

(3) When a_{2b}<a(0)<a₂ₘ, as a third display pattern, support information presentation section 4 displays information regarding an entry (a lane-changing operation) of host vehicle 10 into the rear space of second peripheral vehicle 11b, and simultaneously displays information regarding a decrease in the host vehicle's acceleration.

(4) When a₂ₘ≦a(0)<a_{2f}, as a fourth display pattern, support information presentation section 4 displays information regarding an entry (a lane-changing operation) of host vehicle 10 into the intermediate space defined between first and second peripheral vehicles 11a and 11b, and simultaneously displays information regarding an increase in the host vehicle's acceleration.

(5) When a_{2f}≦a(0)≦a_{1b}, as a fifth display pattern, support information presentation section 4 displays information regarding an entry (a traffic-merging operation) of host vehicle 10 into the intermediate space of first and second peripheral vehicles 11a and 11b.

(6) When a_{1b}<a(0)≦aₘₐₓ, as a sixth display pattern, support information presentation section 4 displays information regarding an entry (a traffic-merging operation) of host vehicle 10 into the intermediate space of first and second peripheral vehicles 11a and 11b, and simultaneously displays information regarding a decrease in the host vehicle's acceleration.

The system itself of the first embodiment (FIGS. 1-11) determines which of gaps should be suited for an entry of host vehicle 10 into a traffic lane of destination of lane-changing, and forcibly positively informs the driver of the decision result (the optimum traffic-merging enabling gap or the optimum lane-changing enabling gap). However, it will be appreciated that all of drivers do not always want to be forcibly positively informed or notified by the support system. Therefore, in the system of the second embodiment, displayed contents selector 9, comprised of dial switch 17, is provided, such that the displayed contents (displayed information) can be manually selected by the driver.

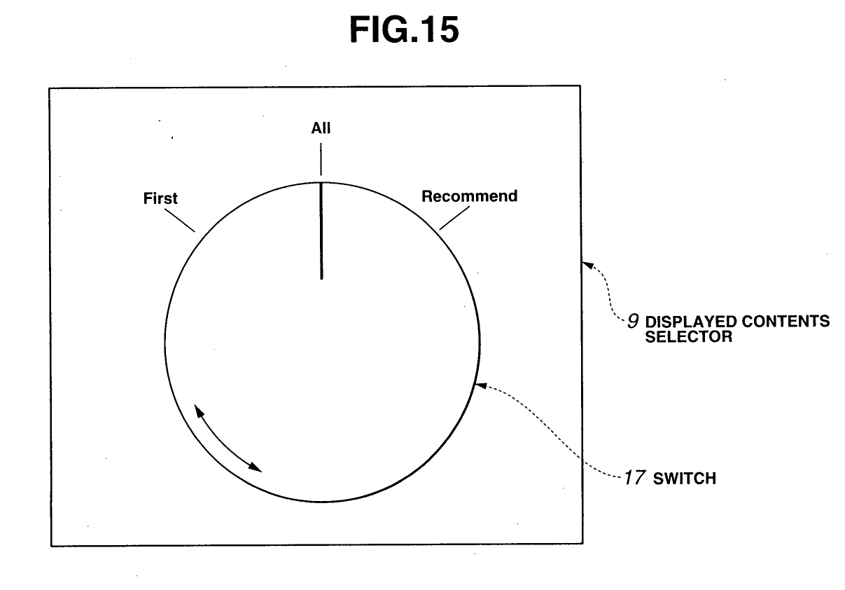

As can be seen from the schematic diagram of FIG. 15 showing dial switch 17 of displayed contents selector 9, in the shown embodiment there are three items selected by dial switch 17, namely three dial angular positions respectively denoted by “Recommend”, “All”, and “First”.

In FIG. 15, when the first item (1^{st} dial angular position) denoted by “Recommend” is selected by the driver, in the same manner as the support information procedure of the system of the first embodiment, the actual acceleration of host vehicle 10 (the current host vehicle acceleration a(0)) is evaluated based on the six classified acceleration ranges (1)-(6), and the evaluation result is displayed as support information.

When the second item (2^{nd} dial angular position) denoted by “All” is selected by the driver, lane-changing enabling gaps are all displayed by way of markers (voided arrows) regardless of the current host vehicle acceleration a(0), so as to inform the driver of all lane-changing enabling gaps. In this case, the current host vehicle acceleration a(0) is compared to a desired acceleration value required for the host vehicle's entry into each of the lane-changing enabling gaps, and then information concerning a required host vehicle acceleration change (a required vehicle acceleration increase/decrease) is also informed and displayed.

When the third item (3^{rd} dial angular position) denoted by “First” is selected by the driver, only the foremost gap of lane-changing enabling gaps is displayed by way of a marker (a voided arrow). For instance, as shown in FIG. 14, if there are two lane-changing enabling gaps corresponding to the two classified current host vehicle's acceleration ranges (2) and (5), namely, a_{3f}<a(0)≦a_{2b} and a_{2f}≦a(0)≦a_{1b}, the intermediate space defined between first and second peripheral vehicles 11a and 11b is determined as the foremost gap and thus a marker is displayed so as to point out the intermediate space. In this case, the current host vehicle acceleration a(0) is compared to a desired acceleration value required for the host vehicle's entry into the foremost gap of the lane-changing enabling gaps, and then information on a required host vehicle acceleration change (a required vehicle acceleration increase/decrease) is also informed and displayed.

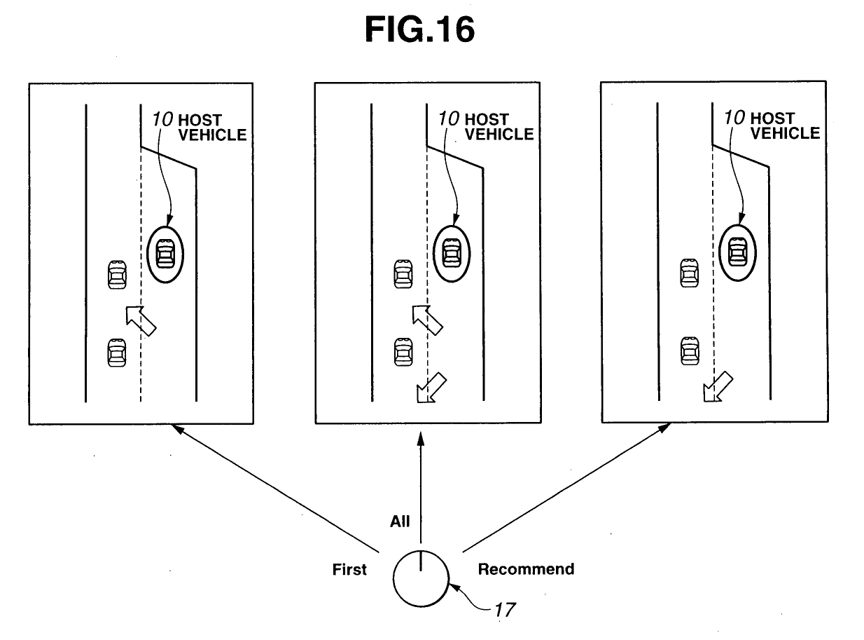

For instance, assuming that the current host vehicle's acceleration exists within the acceleration range (3) of the six classified acceleration ranges (1)-(6), that is, when a_{2b}<a(0)<a₂ₘ, the relationship between setting of the desired item with dial switch 17 and the displayed support information is shown in FIG. 16. As seen from the explanatory view of FIG. 16, in case of selection of the first item “Recommend”, the system evaluates that the current host vehicle acceleration exists within the acceleration range (3), i.e., a_{2b}<a(0)<a₂ₘ, and the rear space of second peripheral vehicle 11b is determined as a lane-changing enabling gap that the appropriate traffic-merging operation of host vehicle 10 can be attained with a minimum driver's manipulated variable change, that is, with a host vehicle acceleration decrease. As a result, a marker (a voided arrow) points out the rear space of second peripheral vehicle 11b (see the right-hand side displayed information of FIG. 16). In case of selection of the second item “All”, lane-changing enabling gaps (that is, the intermediate space defined between first and second peripheral vehicles 11a and 11b and the rear space of second peripheral vehicle 11b) are all displayed by way of markers (voided arrows) irrespective of the current host vehicle acceleration a(0) (see the central displayed information of FIG. 16). On the contrary, in case of selection of the third item “First” and the current host vehicle's acceleration existing within the acceleration range (3), the system selects the intermediate space defined between first and second peripheral vehicles 11a and 11b as the foremost gap. As a result, a marker (a voided arrow) points out the intermediate space defined between first and second peripheral vehicles 11a and 11b (see the left-hand side displayed information of FIG. 16).

As explained above, as input means for information data to be input into lane-changing necessity decision section 3a, the lane-changing support system of the second embodiment includes GPS signal receiving unit 5 (a position information receiving unit or position information receiving means) that receives or gets information concerning a current three-dimensional position of host vehicle 10, map information database 6 whose road-networks information is collated with the current host vehicle's position detected by GPS signal receiving unit 5 to identify the current host vehicle's traveling road, and traffic information receiving unit 8 serving as traffic information receiving means that receives or gets traffic information such as traffic-lane regulation 16. The lane-changing support system of the second embodiment includes lane-changing necessity decision section 3a that determines that there is a necessity of lane-changing when the current host vehicle's driving lane is regulated ahead of host vehicle 10 owing to traffic-lane regulation 16. The system of the second embodiment also includes end-of-traffic-merging setting section 3b that sets or determines traffic-merging end x_{end} as an arbitrary position, which is located upstream of a starting point where traffic-lane regulation 16 starts, and spaced apart from the starting point of traffic-lane regulation 16 by a predetermined distance. As discussed above, the system of the second embodiment is designed to make a decision on a necessity of lane-changing by automatically detecting a point, which requires lane-changing operation and whose traffic-lane width gradually narrows owing to traffic-lane regulation 16, for example road repairs or road construction work. Thus, the system of the second embodiment can present or display optimum support information when host vehicle 10 approaches such a point that requires lane-changing operation owing to a traffic-lane regulation.

Additionally, in the system of the second embodiment, support information presentation section 4 further includes displayed contents selector 9 (a presented information designation device or a man-machine interface), serving as a presented information or displayed information designation means, through which the driver is able to arbitrarily designate or determine which of information patterns (e.g., “Recommend”, “All”, and “First”) of lane-changing enabling gaps should be selected and which of lane-changing enabling gaps should be actually displayed and transmitted to the driver as optimum support information. In this manner, the driver itself can select the actually displayed information of lane-changing enabling gaps, concretely, a recommended gap of the enabling gaps in the “Recommend” mode, all gaps of the enabling gaps in the “All” mode, and the foremost gap of the enabling gaps in the “First” mode. Thus, it is possible to selectively present or display only the driver's required information.

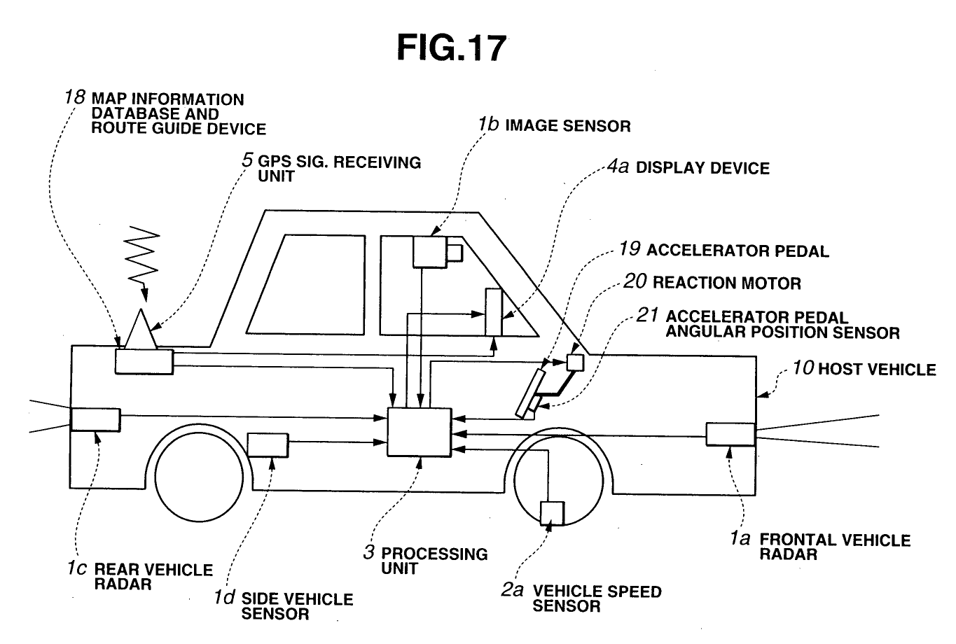

Referring now to FIGS. 17, 18, and 19A-19C, there is shown the lane-changing support system (or the automotive traffic-merging support system) of the third embodiment. FIG. 17 shows the schematic layout of components constructing the lane-changing support system of the third embodiment. The basic components of the system of the third embodiment are identical to those (1a, 1b, 1c, 1d, 1d, 2a, 3, 4a, and 5) of the first embodiment. The system of the third embodiment further includes a reaction motor 20 and an accelerator-pedal angular position sensor 21. Reaction motor 20 is provided to adjust a reaction force of an accelerator pedal 19, whereas accelerator-pedal angular position sensor 21 is provided to detect an angular position of accelerator pedal 19. In the system of the third embodiment of FIG. 17, a map information database and route guide device 18 is provided instead of using only the map information database 6.

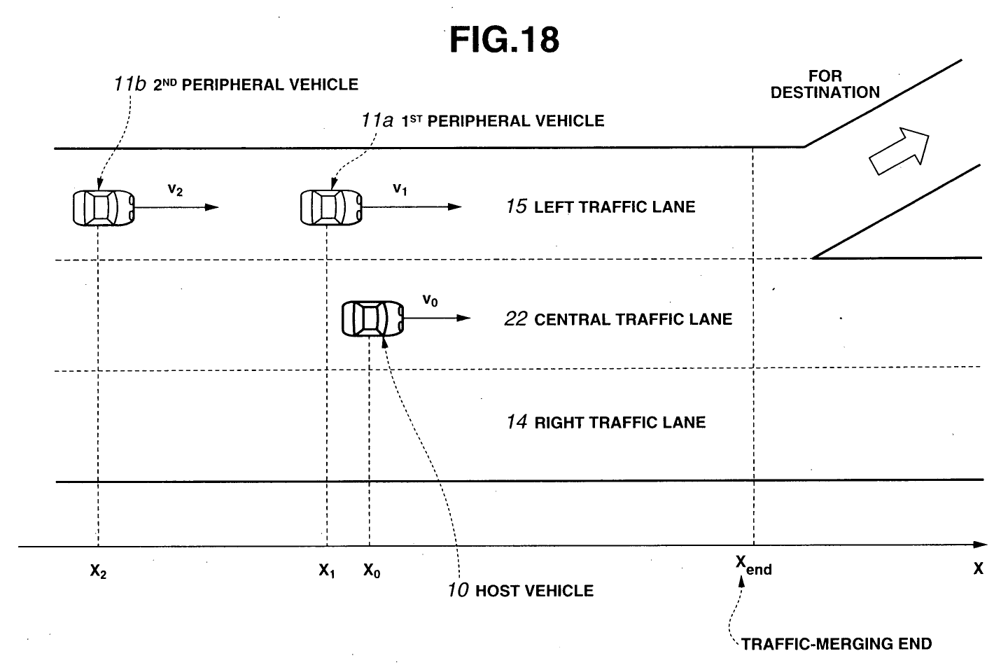

Support information processing executed by the system of the third embodiment is hereunder described in reference to the third traffic situation shown in FIG. 18. FIG. 18 shows the third traffic situation in which one half of the highway is constructed by three lanes 14, 15 and 22, the one half of the highway is branched into two lanes ahead of host vehicle 10 such that the left traffic lane 15 of the closely juxtaposed two traffic lanes is separated from the central traffic lane 22 owing to a branch point, host vehicle 10 travels on the central traffic lane 22, and other vehicles, namely first and second peripheral vehicles 11a and 11b, both travel on the left traffic lane 15. In the third traffic situation, in order for host vehicle 10 to advance or route to a driver-selected destination (or a destination determined based on a driver's intention), host vehicle 10 must be directed and advanced from the current host vehicle's driving lane (central traffic lane 22) to left traffic lane 15 directly connected to the branched lane. Therefore, there is a necessity of lane-changing to left traffic lane 15 before host vehicle 10 reaches the branch point.

In the third traffic situation of FIG. 18, the arithmetic and logic processes executed by processing unit 3 incorporated in the system of the third embodiment are substantially identical to those of the system of the first embodiment. Thus, the arithmetic and logic processes achieved by processing unit 3 of the system of the third embodiment are executed substantially in accordance with the support information processing program as shown in FIG. 11. The arithmetic and logic processing of the system of the third embodiment (FIGS. 17-19) is somewhat different from that of the first embodiment (FIGS. 1-11), in that in the system of the third embodiment a decision process for determining the necessity of lane-changing at step S3 is performed, while taking into account information on route guidance for the driver-selected destination, which is selected, set or determined by the driver via another man-machine interface. For instance, the logic circuit of processing unit 3 of the system of the third embodiment determines that there is a necessity of lane-changing, when a distance between host vehicle 10 and the branch point becomes less than or equal to a predetermined distance such as 500 meters and additionally host vehicle 10 cannot be routed to the driver-selected destination if continuously keeping the host vehicle's traveling on the current driving lane (central traffic lane 22).

When the logic circuit of processing unit 3 determines that there is a necessity of lane-changing, the routine proceeds from step S3 to step S4. At step S4, traffic-merging end x_{end} is set to an arbitrary position before the branch point.

Regarding detailed contents of arithmetic and logic processes executed after traffic-merging end x_{end} has been set, the lane-changing support procedure made by the system of the third embodiment is mathematically or algorithmically identical to the traffic-merging support procedure made by the system of the first embodiment. Thus, within the processing unit of the system of the third embodiment, after the decision process of step S4, the same processes as steps S5-S11 shown in FIG. 11 are executed. In the system of the third embodiment, suppose that as a result of the processes of steps S1-S11 the same correspondence shown in FIG. 9 has been obtained in the same manner as the first embodiment. The method to present support information by the system of the third embodiment is different from that of the first embodiment. As already discussed previously, in the system of the first embodiment, there are seven support information display patterns (1)-(7) corresponding to seven acceleration ranges aₘᵢₙ≦a(0)≦a_{2b}, a_{2b}<a(0)≦a₂ₘ, a₂ₘ<a(0)<a_{2f}, a_{2f}≦a(0)≦a_{1b}, a_{1b}<a(0)≦a₁ₘ, a₁ₘ<a(0)<a_{1f}, and a_{1f}≦a(0)≦aₘₐₓ, shown in FIG. 9. Of these support information display patterns (1)-(7), there are two patterns, each of which instructs a decrease in the host vehicle's acceleration, namely the patterns (2) and (5). In the system of the third embodiment, as an advantageous lane-changing support method further added to audible and visual information provision, a reaction force F of accelerator pedal 19 is automatically increased when the current host vehicle acceleration a(0) exists within either one of these patterns (2) and (5), both instructing a host vehicle acceleration decrease, so as to more positively inform the driver about a necessity of the host vehicle's acceleration decrease.

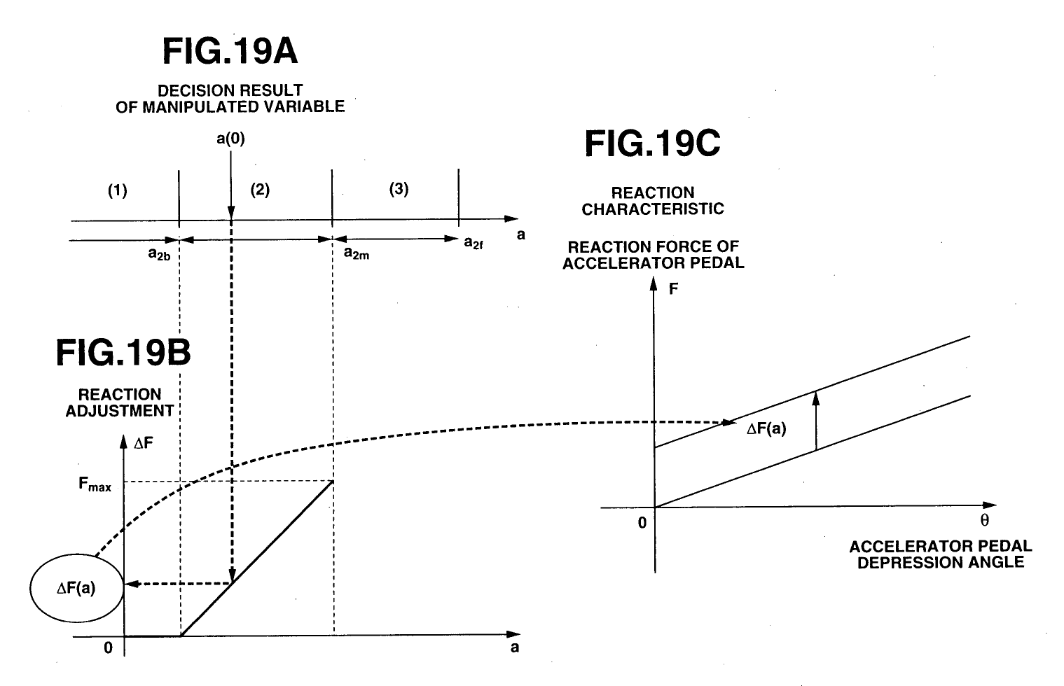

Details of automatic adjustment of reaction force of accelerator pedal 19 are hereunder explained in reference to FIGS. 19A-19C. The concrete example of automatic reaction-force adjustment shown in FIGS. 19A-19C is exemplified in the previously-discussed second support information display pattern (2), corresponding to acceleration range a_{2b}<a(0)≦a₂ₘ. That is, under a condition where the current host vehicle acceleration a(0) is within the acceleration range a_{2b}<a(0)≦a₂ₘ, as seen from FIGS. 19A and 19B, an increasing amount ΔF in accelerator pedal's reaction force F is set to “0” at the boundary point (i.e., a(0)=a_{2b}) between the two patterns (1) and (2). On the other hand, the increasing amount ΔF in accelerator-pedal reaction force F is set to a predetermined maximum value Fₘₐₓ at the boundary point (i.e., a(0)=a_{2f}) between the two patterns (2) and (3). Thus, an reaction-force increasing amount ΔF of the intermediate range extending between the these two boundary points, that is, a_{2f}<a(0)<a_{2f}, is represented by the following expression (18).
ΔF={(a(0)−a_{2b})/(a₂ₘ−a_{2b})}·Fₘₐₓ (18)
That is, increasing amount ΔF of accelerator-pedal reaction force F is defined as a monotone function ΔF={(a(0)−a_{2b})/(a₂ₘ−a_{2b})·Fₘₐₓ. After the processor of the system of the third embodiment has determined increasing amount ΔF of accelerator-pedal reaction force F, the output interface (or the drive circuit) of the system outputs a drive current corresponding to the determined reaction-force increasing amount ΔF to reaction motor 20. As a result of this (by way of the properly increased accelerator-pedal reaction force), it is possible to positively present effective support information on the necessity of the host vehicle's acceleration decrease.

As explained above, as input means for information data to be input into lane-changing necessity decision section 3a, the lane-changing support system of the third embodiment includes map information database and route guide device 18 (map information database and route guide means) that guides a traveling path of host vehicle 10 to the driver-selected destination. The system of the third embodiment includes the lane-changing necessity decision section (3a) that determines that there is a necessity of lane changing of host vehicle 10, when a branch point (a branched lane) exists ahead of host vehicle 10 and the distance between host vehicle 10, and the branch point becomes less than a predetermined distance (a predetermined time span or a predetermined time gap), and the driver-selected destination is branched toward a traveling path different from a traveling path extending along the current host vehicle's driving lane. The system of the third embodiment also includes end-of-traffic-merging setting section 3b that sets or determines traffic-merging end x_{end} as an arbitrary position, which is located upstream of a branch point where one half of the highway is branched into two lanes and one of the two lanes contains a driver-selected destination, and spaced apart from the branch point by a predetermined distance. As discussed above, the system of the third embodiment is designed to make a decision on a necessity of lane-changing by automatically detecting a point, which requires lane-changing operation from the current host vehicle's driving lane to another traffic lane in order for host vehicle 10 to be routed to the driver-selected destination owing to the presence of the branch point. Thus, the system of the third embodiment can present or display optimum support information when host vehicle 10 approaches such a point that requires lane-changing operation owing to the presence of a branch point.

Additionally, in the system of the third embodiment, support information presentation section 4 further includes reaction motor 20, serving as an accelerator-pedal reaction force adjustment device (an accelerator-pedal reaction force adjustment means) through which a reaction force F of accelerator pedal 19 is increased or decreased. When support information presentation section 4 selects an optimum one from the lane-changing enabling gaps, and then support information presentation section 4 determines that a host vehicle acceleration decrease is needed for an appropriate lane change by host vehicle 10 into the selected optimum gap, support information presentation section 4 of the system of the third embodiment operates to increase reaction force F of accelerator pedal 19. As set out above, by way of presentation of support information based on a reaction-force change (a reaction-force increase) of accelerator pedal 19, it is possible to positively inform the driver of a proper host vehicle's manipulated variable (a proper host-vehicle acceleration/deceleration), in a specific traffic situation, in particular in a traffic situation that requires a decelerating operation of host vehicle 10. In other words, it is possible to effectively suppress an immoderate lane change by host vehicle 10 with excessive host-vehicle accelerations or at excessive host vehicle speeds.

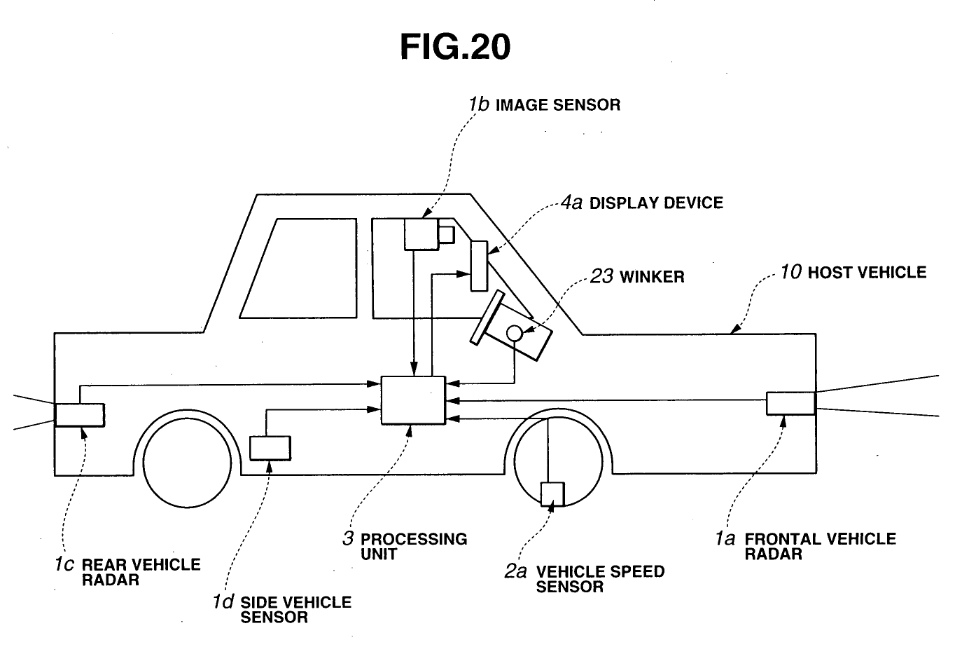

Referring now to FIGS. 20-23, there is shown the lane-changing support system of the fourth embodiment. FIG. 20 shows the schematic layout of components constructing the lane-changing support system of the fourth embodiment. The basic components of the system of the fourth embodiment are identical to those (1a, 1b, 1c, 1d, 1d, 2a, 3, and 4a) of the first embodiment. As can be seen from comparison between the schematic drawings of FIGS. 1 and 20, in the system of the fourth embodiment, GPS signal receiving unit 5 and map information database 6 are eliminated. In stead of using GPS signal receiving unit 5 and map information database 6, the system of the fourth embodiment uses information on an operating state of a winker (or a direction indicator) 23, so as to make a decision on the presence or absence of a driver's intention for lane changing. Processing unit 3 incorporated in the system of the fourth embodiment receives a signal from winker 23, indicative of the actual operating state of winker 23.

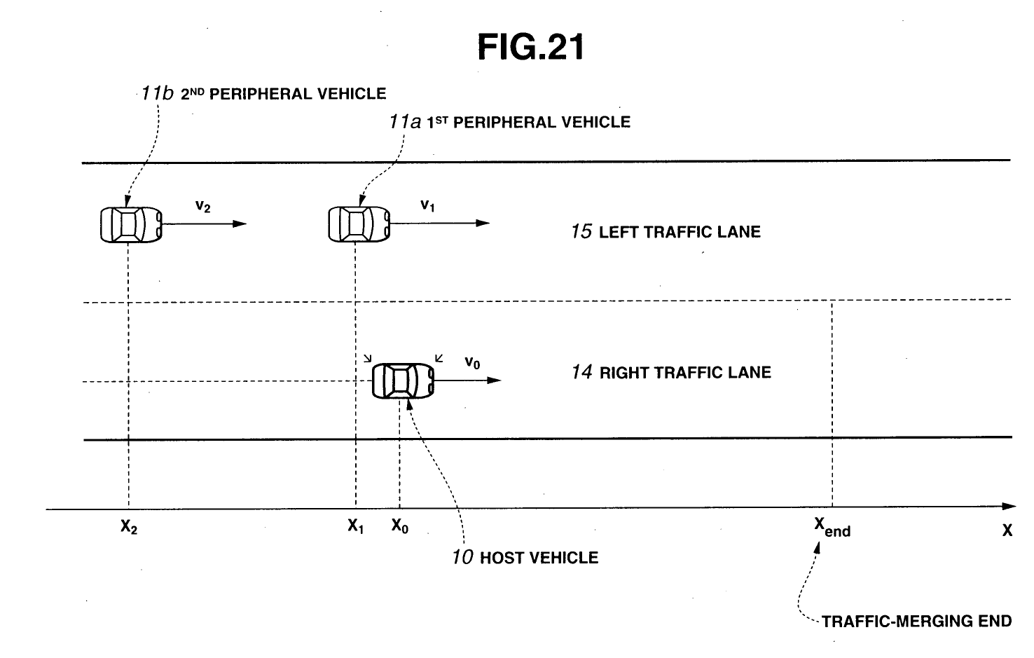

Support information processing executed by the system of the fourth embodiment is hereunder described in reference to the fourth traffic situation shown in FIG. 21. FIG. 21 shows the fourth situation in which one half of the highway is constructed by two lanes 14 and 15, host vehicle 10 travels on right traffic lane 14, and other vehicles, namely first and second peripheral vehicles 11a and 11b travel on left traffic lane 15. Suppose that winker 23 is turned ON and the direction indicated by winker 23 is identical to the leftward direction during a lane-changing period from right traffic lane 14 to left traffic lane 15 with a driver's intention for lane changing. In such a fourth traffic situation of FIG. 21, the arithmetic and logic processes executed by processing unit 3 of the system of the fourth embodiment are substantially identical to those of the system of the first embodiment. Thus, the arithmetic and logic processes achieved by processing unit 3 of the system of the fourth embodiment are executed substantially in accordance with the support information processing program as shown in FIG. 11. The arithmetic and logic processing of the system of the fourth embodiment (FIGS. 20-23) is somewhat different from that of the first embodiment (FIGS. 1-11), in that in the system of the fourth embodiment a decision process for determining the necessity of lane-changing at step S3 is performed, while taking into account information on the operating state of winker 23, in other words, the presence or absence of a driver's intention for lane changing. That is, the system of the fourth embodiment initiates an advantageous lane-changing support action based on the signal from winker 23, in other words, based on the presence or absence of the actual driver's intention for lane changing, instead of autonomously making a decision on a necessity of lane-changing.

When a new operation (a new turned-ON action) of winker 23 has been detected, the routine proceeds from step S3 to step S4. At step S4, traffic merging end x_{end} is set to an arbitrary position ahead of host vehicle 10. In the fourth traffic situation shown in FIG. 21, there is no inevitability that lane-changing operation of host vehicle 10 has to be certainly completed until host vehicle 10 reaches traffic merging end x_{end}. However, traffic merging end x_{end} must be set or determined as a target point for a lane change by host vehicle 10. Actually, traffic merging end x_{end} is set as an arbitrary position, which is located ahead of host vehicle 10, and spaced apart from a host vehicle's position at a point of time where winker 23 has been turned ON, by a predetermined distance. Suppose that a margin from the winker turned-ON time point to a lane-changing initiation time point is preset as a predetermined time T, the x-coordinate of host vehicle 10 at the winker turned-ON time point is denoted by x₀, and the host vehicle speed at the winker turned-ON time point is denoted by v₀. In this case, traffic merging end x_{end} is represented from the following expression (19).
x_{end} =x₀+T·v₀ (19)
If winker 23 has already been in operation and additionally traffic merging end x_{end} has already been set, the set value for traffic merging end x_{end} is kept unchanged.

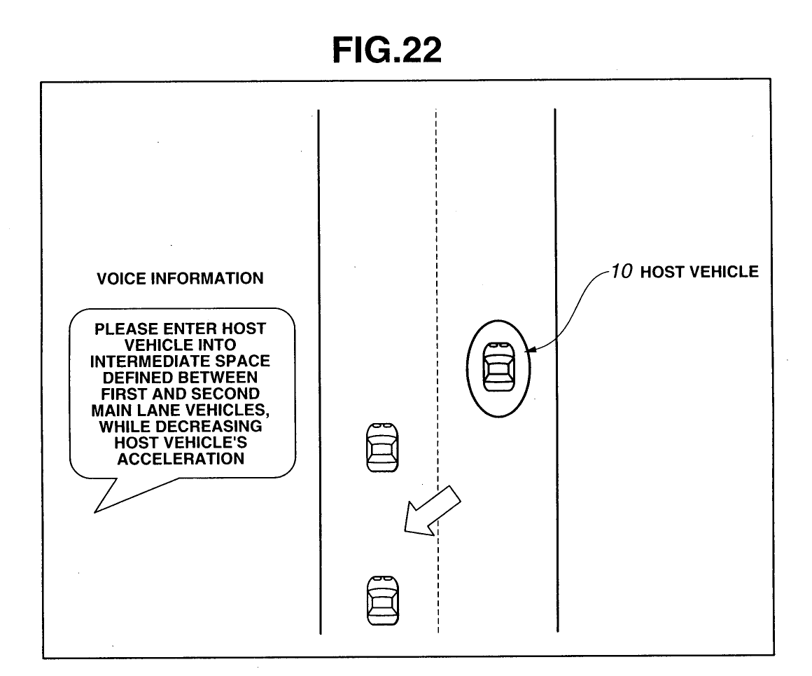

Regarding detailed contents of arithmetic and logic processes executed after traffic-merging end x_{end} has been set, the lane-changing support procedure made by the system of the fourth embodiment is mathematically or algorithmically identical to the traffic-merging support procedure made by the system of the first embodiment. Thus, within the processing unit of the system of the fourth embodiment, after the decision process of step S4, the same processes as steps S5-S11 shown in FIG. 11 are executed. Therefore, support information presentation section 4 of the system of the fourth embodiment can present support information in the same manner as the first embodiment. In the same manner as the example shown in FIG. 10, assuming that the current host vehicle acceleration a(0) corresponds to the fifth display pattern (5), that is, a_{1b}<a(0)≦a₁ₘ, as shown in FIG. 22, a marker, which points out the gap (the intermediate space defined between first and second peripheral vehicles 11a and 11b), is displayed on display device 4a (see the voided arrow of FIG. 22). At the same time, the support information on both of a decrease in host vehicle acceleration and an entry (a traffic-merging operation) of host vehicle 10 into the intermediate space of first and second peripheral vehicles 11a and 11b, is audibly indicated. In case of the fourth traffic situation where there is no inevitability that a lane change by host vehicle 10 has to be always made in the vicinity of traffic merging end x_{end}, there is an increased tendency that the driver's intention for lane-changing is changed and thus host vehicle 10 passes through the firstly-set traffic merging end x_{end} without completion of lane-changing operation. In such a case, as soon as the system determines that host vehicle 10 has passed through the firstly-set traffic merging end x_{end}, the system sets a new traffic merging end (a second traffic merging end) x_{end} at once. Therefore, the system of the fourth embodiment can compute or present new lane-changing support information based on the secondly-set traffic merging end x_{end}.

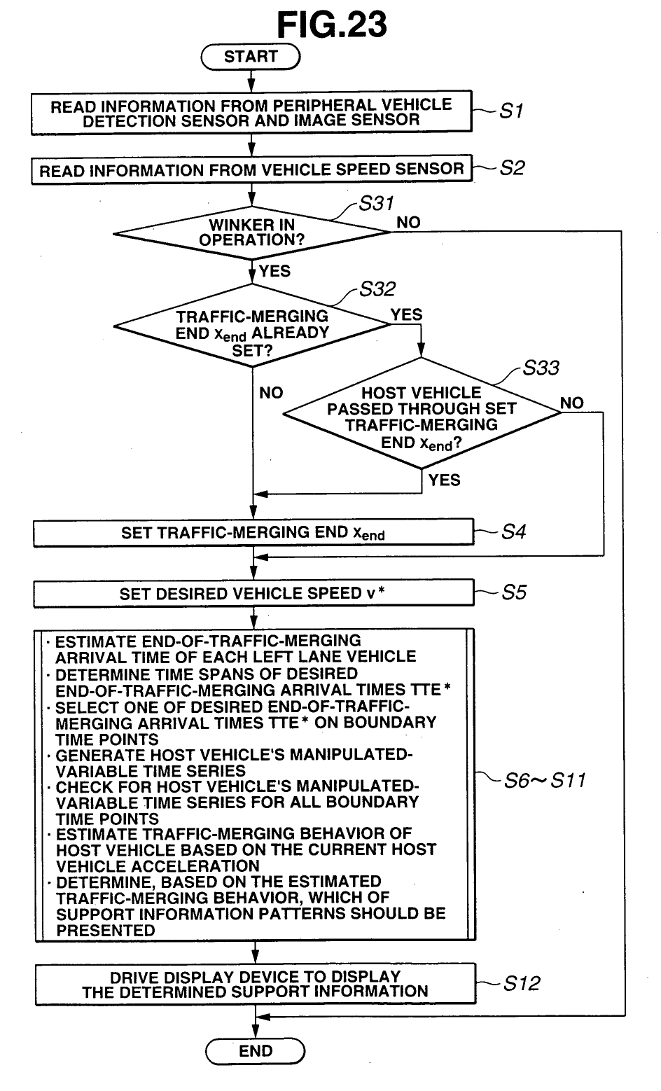

Referring now to FIG. 23, there is shown the lane-changing support routine executed by the system of the fourth embodiment. The routine of FIG. 23 is also executed as time-triggered interrupt routines to be triggered every predetermined time intervals.

The arithmetic and logic processing of FIG. 23 is similar to the arithmetic and logic processing of FIG. 11, except that steps S3 included in the routine shown in FIG. 11 is replaced with steps S31, S32, and S33 included in the routine shown in FIG. 23. Thus, the same step numbers used to designate steps in the routine shown in FIG. 11 will be applied to the corresponding step numbers used in the arithmetic and logic processing shown in FIG. 23, for the purpose of comparison of the two different interrupt routines. Steps S31, S32, and S33 will be hereinafter described in detail with reference to the accompanying drawings, while detailed description of steps S1, S2, and S4-12 will be omitted because the above description thereon seems to be self-explanatory.

At step S31, a check for the operating state of winker 23 is made. Concretely, a check is made to determine whether winker 23 is tuned ON or tuned OFF. When winker 23 is in the tuned-ON state, information on the direction indicated by winker 23 is also transmitted into processing unit 3 of the system of the fourth embodiment, and whereby the system can determine the presence of a driver's intention for lane-changing and the direction of lane-changing. When the answer to step S31 is negative (NO), that is, when winker 23 is kept turned OFF, the system of the fourth embodiment determines that there is no necessity of lane-changing support, and thus one cycle of the lane-changing support routine of FIG. 23 terminates. Conversely when the answer to step S31 is affirmative (YES), that is, when winker 23 is turned ON, the routine proceeds from step S31 to sep S32.

At step S32, a check is made to determine whether traffic-merging end x_{end} has already been set. When the answer to step S32 is negative (NO), that is, traffic-merging end x_{end} has not yet been set, the routine proceeds from step S32 to step S4. On the contrary, when the answer to step S32 is affirmative (YES), that is, traffic-merging end x_{end} has already been set, the routine proceeds from step S32 to step S33.

At step S33, a check is made to determine whether host vehicle 10 has already passed through traffic-merging end x_{end}. When the answer to step S33 is affirmative (YES), the routine proceeds from step S33 to step S4. Conversely when the answer to step S33 is negative (NO), the routine flows from step S33 to step S5.

At step S4, traffic-merging end x_{end} is set or determined based on the previously-discussed expression (19), that is, X_{end}=x₀+T·v₀.

At step S5, desired vehicle speed v* of a point of time at which host vehicle 10 reaches traffic-merging end x_{end}, determined through step S4, is determined based on first and second peripheral vehicle's speeds v₁ and v₂ (see the previously-discussed expressions (16) or (17)).

As explained above, only during a time period in which winker 23 is conditioned in the turned-ON state, the system of the fourth embodiment is designed to logically arithmetically compute or visually audibly display support information on lane-changing of host vehicle 10 into the traffic lane indicated by winker 23. In this manner, according to the system of the fourth embodiment, the presence or absence of a driver's intention for lane-changing is detected based on the operating state of winker 23, and only when winker 23 is in the turned-ON state, in other words, only in presence of the driver's intention for lane-changing, the actual arithmetic and logic processes for lane-changing support are initiated. As soon as a transition from the turned-ON state of winker 23 to the turned-OFF state occurs, the lane-changing support routine terminates. That is, the essential arithmetic and logic circuitries of the system of the fourth embodiment come into operation, only in presence of a driver's intention for lane-changing. In contrast to the above, in the traffic-merging support system-(or the traffic-merging period collision-avoidance system or the traveling object control system) as disclosed in JP10-105895, it is assumed that a traffic-merging lane vehicle and a main lane vehicle are automatically controlled via an arithmetic and logic processing system installed on a highway as a roadside processing system rather than a vehicle-mounted processing system. Thus, in the same manner as the traffic-merging support system disclosed in JP10-105884, the roadside processing system disclosed in JP10-105895 and fixedly mounted on the highway is applicable only a specific situation that lane-changing must be made owing to a road structure such as a gradually-narrowing traffic-merging area. Additionally, such a roadside processing system as disclosed in JP10-105895 is applicable to only a specific vehicle having an automatic control function by which the specific vehicle and the roadside processing system are intercommunicated with each other and the specific vehicle can be automatically controlled in response to an instruction or a command from the roadside processing system. A combination of the roadside processing system and the specific vehicle having the automatic control function is inferior in enhanced applicability, as compared to the vehicle-mounted lane-changing support system of the shown embodiment.

Additionally, in the system of the fourth embodiment shown in FIGS. 20-23, end-of-traffic-merging setting section (end-of-traffic-merging setting means) 3b operates to re-set traffic-merging end x_{end} at a different point downstream of the firstly-set point (firstly-set traffic-merging end x_{end}) under a condition where host vehicle 10 has passed through the firstly-set traffic-merging end x_{end} and additionally a lane-changing permissible point still exists ahead of host vehicle 10. In this-manner, the system of the fourth embodiment enables resetting of traffic-merging end x_{end} if required. Even if host vehicle 10 fails to complete a first lane-changing operation, the system of the fourth embodiment can continually provide lane-changing support information as far as traffic situations (roadway situations) permit a second lane-changing operation of host vehicle 10.

The entire contents of Japanese Patent Application No. 2003-276666 (filed Jul. 18, 2003) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

1. A lane-changing support system comprising:
a host-vehicle driving-state detection section that detects a driving state of a host vehicle;
a peripheral vehicle detection section that detects peripheral vehicles;
a lane detection section that detects a lane marking around the host vehicle; and
a processing unit being configured to receive information from at least the host-vehicle driving-state detection section, the peripheral vehicle detection section, and the lane detection section, for generating support information on lane-changing support; the processing unit comprising:
(a) an end-of-traffic-merging setting section that sets an assumed traffic-merging end serving as a temporary measure at which a lane change by the host vehicle has to be completed;
(b) a peripheral vehicle behavior prediction section that predicts a driving behavior of each of the peripheral vehicles;
(c) a host-vehicle manipulated variable setting section that generates at least one manipulated-variable time series of a host vehicle's manipulated variable to be executed during a time period from a time when a decision that there is a necessity of lane-changing has been made to a time when the host vehicle reaches the assumed traffic-merging end;
(d) a manipulated variable decision section connected to the peripheral vehicle behavior prediction section and the host-vehicle manipulated variable setting section for determining whether the lane change by the host vehicle is appropriately achievable when executing the manipulated-variable time series, generated by the host-vehicle manipulated variable setting section, and additionally determines which of gaps defined between the peripheral vehicles traveling on a traffic lane of destination of lane-changing should be suited for an entry of the host vehicle when the manipulated variable decision section determines that the appropriate lane change by the host vehicle is achievable by execution of the manipulated-variable time series; and
(e) a support information presentation section that transmits information regarding a correspondence between a current host vehicle's manipulated variable on the manipulated-variable time series determined by the manipulated variable decision section and at least one lane-changing enabling gap determined by the manipulated variable decision section, to the driver.

2. The lane-changing support system as claimed in claim 1, wherein:
the peripheral vehicle behavior prediction section estimates end-of-traffic-merging arrival times respectively corresponding to a time of arrival of one of the peripheral vehicles to the traffic-merging end and a time of arrival of the other peripheral vehicle to the traffic-merging end, and
the manipulated variable decision section estimates a desired end-of-traffic-merging arrival time corresponding to a desired time of arrival of the host vehicle to the traffic-merging end, and compares the desired end-of-traffic-merging arrival time of the host vehicle to each of the end-of-traffic-merging arrival times of the peripheral vehicles, and determines, based on the comparison result, whether the lane change by the host vehicle is appropriately achievable.

3. The lane-changing support system as claimed in claim 2, wherein:
the processing unit further comprises a desired vehicle speed setting section that sets a desired host vehicle speed to be attained until the host vehicle reaches the traffic-merging end, and
the host-vehicle manipulated variable setting section generates the manipulated-variable time series according to which the desired host vehicle speed set by the desired vehicle speed setting section is reached at the traffic-merging end.

4. The lane-changing support system as claimed in claim 3, wherein:
the host-vehicle manipulated variable setting section generates the manipulated-variable time series according to which the desired host vehicle speed set by the desired vehicle speed setting section is reached at the traffic-merging end, and additionally the host vehicle is timed to arrive at the traffic-merging end at the desired end-of-traffic-merging arrival time, and
the manipulated variable decision section designates a candidate of the host vehicle's manipulated variable for manipulated-variable decision in terms of an end-of-traffic-merging arrival time.

5. The lane-changing support system as claimed in claim 3, wherein:
the desired vehicle speed setting section determines the desired host vehicle speed, based on peripheral vehicle speeds of the peripheral vehicles traveling on the traffic lane of destination of lane-changing.

6. The lane-changing support system as claimed in claim 1, wherein:
only during a time period during which a winker is kept in a turned-ON state, arithmetic and logic processes and displaying action for support information on lane-changing of the host vehicle to a traffic lane indicated by the winker are executed.

7. The lane-changing support system as claimed in claim 1, wherein:
the processing unit further comprises a lane-changing necessity decision section that autonomously makes a decision on the necessity of lane-changing and the traffic lane of designation of lane-changing, and
only during a time period during which the lane-changing necessity decision section determines that there is a necessity of lane-changing, arithmetic and logic processes and displaying action for support information on lane-changing of the host vehicle to a traffic lane indicated by the winker are executed.

8. The lane-changing support system as claimed in claim 7, wherein:
the lane-changing necessity decision section determines that there is a necessity of lane-changing, when a current driving lane of the host vehicle is merged into a traffic lane closely juxtaposed to the current host vehicle's driving lane at a traffic-merging point ahead of the host vehicle, and
the end-of-traffic-merging setting section sets the traffic-merging end as an arbitrary position, which is located upstream of a lane-termination point that the current host vehicle's driving lane is completely vanishes into nothing, and spaced apart from the lane-termination point by a predetermined distance.

9. The lane-changing support system as claimed in claim 7, further comprising:
a position information receiving section that receives information concerning a current three-dimensional position of the host vehicle and serves as input means for information data to be input into the lane-changing necessity decision section, and
a traffic information receiving unit that receives traffic information including traffic-lane regulation and serves as the input means for information data to be input into the lane-changing necessity decision section,
wherein the lane-changing necessity decision section determines that there is a necessity of lane-changing, when the current host vehicle's driving lane is regulated ahead of the host vehicle owing to the traffic-lane regulation, and
the end-of-traffic-merging setting section sets the traffic-merging end as an arbitrary position, which is located upstream of a starting point where the traffic-lane regulation starts, and spaced apart from the starting point of the traffic-lane regulation by a predetermined distance.

10. The lane-changing support system as claimed in claim 7, further comprising:
a route guide device that guides a traveling path of the host vehicle to a driver-selected destination and serves as input means for information data to be input into the lane-changing necessity decision section,
wherein the lane-changing necessity decision section determines that there is a necessity of lane changing, when a branch point exists ahead of the host vehicle, and a distance between the host vehicle and the branch point becomes less than a predetermined distance, and the driver-selected destination is branched toward a traveling path different from a traveling path extending along the current host vehicle's driving lane, and
the end-of-traffic-merging setting section sets the traffic-merging end as an arbitrary position, which is located upstream of the branch point, and spaced apart from the branch point by a predetermined distance.

11. The lane-changing support system as claimed in claim 7, wherein:
the end-of-traffic-merging setting section re-sets the traffic-merging end at a different point downstream of a firstly-set point of the traffic-merging end under a condition where the host vehicle has passed through the firstly-set point of the traffic-merging end and additionally a lane-changing permissible point still exists ahead of the host vehicle.

12. The lane-changing support system as claimed in claim 1, wherein:
the support information presentation section informs the driver of information regarding which of gaps of the traffic lane of destination of lane-changing should be selected as lane-changing enabling gaps each permitting an appropriate entry of the host vehicle into the traffic lane of destination with a minimum change in the current host vehicle's manipulated variable serving as a reference.

13. The lane-changing support system as claimed in claim 1, wherein:
the support information presentation section informs the driver of information regarding a foremost gap of the lane-changing enabling gaps.

14. The lane-changing support system as claimed in claim 1, wherein:
the support information presentation section comprises a presented information designation device serving as a man-machine interface for arbitrarily and manually determining which of information patterns of the lane-changing enabling gaps should be selected.

15. The lane-changing support system as claimed in claim 1, wherein:
the support information presentation section informs the driver of information on whether the host vehicle should be accelerated or decelerated from a current host vehicle speed in order to realize an appropriate lane change of the host vehicle into the lane-changing enabling gap selected by the manipulated variable decision section.

16. The lane-changing support system as claimed in either claim 1, wherein:
the support information presentation section comprises a display device, and which further comprises:
a peripheral map drawing section, which is data-linked to the support information presentation section, and draws a peripheral map indicative of a layout of the peripheral vehicles, based on a signal from the peripheral vehicle detection section, on the display device of the support information presentation section, and
wherein the support information presentation section informs the driver of a decision result on lane-changing support by overwriting at least one of a first marker, which points out the lane-changing enabling gap selected by the manipulated variable decision section and a second marker, which indicates information on a host vehicle acceleration change needed for the appropriate lane change of the host vehicle into the selected lane-changing enabling gap, on the displayed peripheral map.

17. The lane-changing support system as claimed in claim 1, wherein:
the support information presentation section selects an optimum one from the lane-changing enabling gaps, and informs the driver of a decision result on lane-changing support by audibly instructing and guiding support information on both of the selected optimum gap and required host vehicle's manipulation to be taken by the driver for the appropriate lane change of the host vehicle into the selected optimum gap.

18. The lane-changing support system as claimed in claim 1, wherein:
the support information presentation section comprises an accelerator-pedal reaction force adjustment device through which an accelerator-pedal reaction force is increased or decreased, and
when the support information presentation section selects an optimum one from the lane-changing enabling gaps, and then the support information presentation section determines that a host vehicle acceleration decrease is needed for an appropriate lane change by the host vehicle into the selected optimum gap, the support information presentation section increases the accelerator-pedal reaction force.

19. A lane-changing support system comprising:
host-vehicle driving-state detection means for detecting a driving state of a host vehicle;
peripheral vehicle detection means for detecting peripheral vehicles;
lane detection means for detecting a lane marking around the host vehicle; and
a processing unit being configured to receive information from at least the host-vehicle driving-state detection means, the peripheral vehicle detection means, and the lane detection means, for generating support information on lane-changing support; the processing unit comprising:
(a) end-of-traffic-merging setting means for setting an assumed traffic-merging end serving as a temporary measure at which a lane change by the host vehicle has to be completed;
(b) peripheral vehicle behavior prediction means for predicting a driving behavior of each of the peripheral vehicles;
(c) host-vehicle manipulated variable setting means for generating at least one manipulated-variable time series of a host vehicle's manipulated variable to be executed during a time period from a time when a decision that there is a necessity of lane-changing has been made to a time when the host vehicle reaches the assumed traffic-merging end;
(d) manipulated variable decision means connected to the peripheral vehicle behavior prediction means and the host-vehicle manipulated variable setting means for determining whether the lane change by the host vehicle is appropriately achievable when executing the manipulated-variable time series, generated by the host-vehicle manipulated variable setting means, and additionally determines which of gaps defined between the peripheral vehicles traveling on a traffic lane of destination of lane-changing should be suited for an entry of the host vehicle (10) when the manipulated variable decision means determines that the appropriate lane change by the host vehicle is achievable by execution of the manipulated-variable time series; and
(e) support information presentation means for transmitting information regarding a correspondence between a current host vehicle's manipulated variable on the manipulated-variable time series determined by the manipulated variable decision means and at least one lane-changing enabling gap determined by the manipulated variable decision means, to the driver.

20. A lane-changing support method comprising:
detecting a driving state of a host vehicle;
detecting peripheral vehicles;
detecting a lane marking around the host vehicle;
generating support information on lane-changing support by processing information regarding the driving state of the host vehicle, the peripheral vehicles, and the lane marking around the host vehicle; the process for generating the support information comprising:
(a) setting an assumed traffic-merging end serving as a temporary measure at which a lane change by the host vehicle has to be completed;
(b) predicting a driving behavior of each of the peripheral vehicles;
(c) generating at least one manipulated-variable time series of a host vehicle's manipulated variable to be executed during a time period from a time when a decision that there is a necessity of lane-changing has been made to a time when the host vehicle reaches the assumed traffic-merging end;
(d) based on the driving behavior of each of the peripheral vehicles and the manipulated-variable time series of the host vehicle's manipulated variable, determining whether the lane change by the host vehicle is appropriately achievable when executing the manipulated-variable time series, and additionally determining which of gaps defined between the peripheral vehicles traveling on a traffic lane of destination of lane-changing should be suited for an entry of the host vehicle in case of a decision result that the appropriate lane change by the host vehicle is achievable by execution of the manipulated-variable time series; and
(e) transmitting information regarding a correspondence between a current host vehicle's manipulated variable on the manipulated-variable time series determined and at least one lane-changing enabling gap determined, to the driver.
